(19) United States
(12) Patent Application Publication
(10) Pub. No.: US 2022/0205119 A1
(43) Pub. Date: Jun. 30, 2022

(54) HIGHLY ACTIVE AND STABLE STEPPED CU BASED ELECTROCHEMICAL CATALYST

(71) Applicant: THE REGENTS OF THE UNIVERSITY OF CALIFORNIA, Oakland, CA (US)

(72) Inventors: Yu HUANG, Los Angeles, CA (US); Chungsuk CHOI, Los Angeles, CA (US); Xiangfeng DUAN, Los Angeles, CA (US)

(73) Assignee: THE REGENTS OF THE UNIVERSITY OF CALIFORNIA, Oakland, CA (US)

(21) Appl. No.: 17/564,050

(22) Filed: Dec. 28, 2021

Related U.S. Application Data
(60) Provisional application No. 63/132,281, filed on Dec. 30, 2020.

(51) Int. Cl. C25B 11/075; C25B 3/03; C25B 3/26

(52) U.S. Cl. CPC C25B 11/075; C25B 3/26; C25B 3/03

(57) ABSTRACT

Electrochemical catalysts for the reduction of CO₂ to hydrocarbons, such as ethylene, include Cu nanowires, wherein the Cu nanowires include a stepped surface.

### CROSS REFERENCE TO RELATED APPLICATIONS

This application claims the benefit of priority to U.S. Provisional Patent Application No. 63/132,281 filed Dec. 30, 2020, which is hereby incorporated by reference, in its entirety for any and all purposes.

### GOVERNMENT RIGHTS

This invention was made with government support under Grant Number N000141712608, awarded by the U.S. Navy, Office of Naval Research. The government has certain rights in the invention.

### FIELD

The present technology generally relates to electrocatalysts for the carbon dioxide reduction reaction, and in particular to copper based electrocatalysts having a stepped surface.

### BACKGROUND

Electrochemical CO₂ reduction to valuable fuels is a promising approach to mitigate energy and environmental problems, but controlling the reaction pathways and products remains challenging. For instance, ethylene (C₂H₄) is desirable product of carbon dioxide reduction reaction (CO₂RR) since it is a basic building block to produce various plastics, solvents, and cosmetics. However, the selective production of C₂H₄ from CO₂RR is challenging, with competition from the hydrogen evolution reaction (HER) and methane (CH₄) production.

Several metal electrodes are known to catalyze the carbon dioxide reduction reaction (CO₂RR) in aqueous solutions. Among all catalysts explored to date, copper (Cu) is the only electrocatalytic material that converts CO₂ to hydrocarbons products with significant activity and efficiency. Due to its natural abundance and low cost, copper based catalysts for electrochemical CO₂RR have been intensively studied for decades. However, the low product selectivity towards valuable fuel products and the lack of long-term stability remain major challenges for Cu based catalysts. Thus, there remains a need to develop highly-efficient Cu based electrocatalysts for electrochemical CO₂RR that are stable and are highly selective for desired products, such as ethylene.

Described herein are Cu based electrocatalysts (e.g., Cu nanowires) that have a stepped surface. Such catalysts are stable, highly active, and have high product selectivity for ethylene in the electrochemical reduction of CO₂.

### SUMMARY

In one aspect, is a catalyst including Cu nanowires, wherein the Cu nanowires include a stepped surface.

In some embodiments, the Cu nanowires are coated on an electrode. In some embodiments, the Cu nanowires include a Cu(511) plane stepped surface. In some embodiments, the stepped surface includes Cu(100) terraces adjacent to Cu(111) steps, where the terraces are formed in an axial direction and the steps are present as planes on a side surface of a Cu nanowire.

In some embodiments, the Cu nanowires have an electrochemical surface area (ECSA) of greater than 1.68 m²/g. In some embodiments, the Cu nanowires have an electrochemical surface area (ECSA) of about 2.9 m²/g to about 3.5 m²/g. In some embodiments, the Cu nanowires have an electrochemical surface area (ECSA) of about 3.0 m²/g to about 3.1 m²/g. In some embodiments, the Cu nanowires have an electrochemical surface area (ECSA) of about 3.07 m²/g.

In some embodiments, the Cu nanowires have a surface roughness factor (SRF) of less than 18. In some embodiments, the Cu nanowires have a surface roughness factor (SRF) of about 10 to about 18. In some embodiments, the Cu nanowires have a surface roughness factor (SRF) of less than 17.86. In some embodiments, the Cu nanowires have a surface roughness factor (SRF) of about 11.35.

Also provided in another aspect is a method of making Cu nanowires with a stepped surface, including:

preparing Cu nanowires; and

applying an electrical current under a high reduction bias thereby forming the stepped surface on the Cu nanowires;

wherein the stepped surface includes Cu(100) terraces adjacent to Cu(111) steps, where the terraces are formed in an axial direction and the steps are present as planes on a side surface of a Cu nanowire.

In some embodiments, the high reduction bias is from about −0.75 V to about −1.5 V. In some embodiments, the high reduction bias is about −1.05 V. In some embodiments, the method is performed in a H-cell.

Also provided in another aspect is a method of reducing CO₂, including:

contacting CO₂ with a catalyst including Cu nanowires, wherein the Cu nanowires comprise a stepped surface; and

applying an electrical current sufficient to reduce the CO₂ to form a hydrocarbon;

wherein the stepped surface includes Cu(100) terraces adjacent to Cu(111) steps, where the terraces are formed in an axial direction and the steps are present as planes on a side surface of a Cu nanowire.

In some embodiments, the hydrocarbon is C₂H₄. In some embodiments, the method provides C₂H₄ at a selectivity of at least 50%. In some embodiments, the method provides C₂H₄ at a selectivity of at least 70%. In some embodiments, the method provides C₂H₄ at a selectivity of at least 55%, at least 60%, at least 65%, at least 70%, at least 75%, at least 80%, at least 85%, at least 90%, or at least 95%. In some embodiments, the method provides C₂H₄ at a selectivity of about 55%, about 60%, about 65%, about 70%, about 75%, about 80%, about 85%, about 90%, or about 95%. In some embodiments, the method provides C₂H₄ at a selectivity of from about 50% to about 85%, from about 55% to about 85%, from about 60% to about 85%, or from about 60% to about 80%.

In some embodiments, the Cu nanowires have a stability of greater than 10 hours, greater than 25 hours, greater than 50 hours, greater than 75 hours, greater than 100 hours, greater than 125 hours, greater than 150 hours, greater than 175 hours, or greater than 200 hours. In some embodiments, the Cu nanowires have a stability of about 10 hours, about 25 hours, about 50 hours, about 75 hours, about 100 hours, about 125 hours, about 150 hours, about 175 hours, or about 200 hours. In some embodiments, the Cu nanowires have a stability of from about 10 hours to about 250 hours, from about 10 hours to about 200 hours, from about 25 hours to about 250 hours, from about 25 hours to about 200 hours, from about 75 hours to about 250 hours, from about 75 hours to about 200 hours, from about 100 hours to about 250 hours, or from about 100 hours to about 200 hours.

In some embodiments, the method is performed in a H-cell.

### BRIEF DESCRIPTION OF THE DRAWINGS

FIGS. 1A and 1B provide a schematic of preparing CuNWs with surface steps. FIG. 1A depicts the as-synthesized CuNWs with {100} surface. FIG. 1B depicts that the CuNWs is activated in situ during the electrochemical CO₂RR to form surface steps.

FIGS. 2A, 2B, 2C, and 2D provide the TEM characterizations of the Syn-CuNW and A-CuNW. FIG. 2A shows the low magnification TEM image of Syn-CuNWs (insets: schematic illustration (top) and HRTEM (bottom) of a Syn-CuNW, showing electron beam direction, <110> NW axial growth direction and expressed {100} side facets). FIG. 2B shows the low magnification TEM image of A-CuNW. FIG. 2C shows the HRTEM image of A-CuNW (inset: FFT of the corresponding Cu phase, indicating <110> axial direction and expression of {100} planes on the side surface. FIG. 2D shows the HRTEM image of an A-CuNW surface indicating step structure (insert: FFT from yellow box).

FIGS. 3A, 3B, 3C, 3D, 3E, and 3F provide the electrochemical characterization of the surfaces of the CuNWs. FIG. 3A shows the redox reaction of Syn-CuNWs and A-CuNWs in 0.1 M KOH. FIGS. 3B, 3C, 3D, and 3E show the fitted OH⁻ adsorption peaks of Syn-CuNWs (FIG. 3B, inset is a schematic of the corresponding Syn-CuNW structure) and A-CuNWs with different activation duration: FIG. 3C: 0.5 h, FIG. 3D: 1 h, and FIG. 3E: 1.5h. Peaks of different color represent different facets on the NW surfaces. Blue color—{100} facets, green color—{110} facets, and red color—A-(hkl) (steps), black open circle (original data), yellow open circle (fitted data). FIG. 3F shows the correlation between the portion of surface facet and the activation duration on A-CuNW surface, showing increasing A-(hkl) with longer activation.

FIGS. 4A, 4B, 4C, 4D, and 4E provide the electrochemical CO₂RR performance. FIG. 4A depicts the FEs of Cu foil; FIG. 4B depicts the FEs of Syn-CuNWs; and FIG. 4C depicts the FEs of A-CuNWs. The error bars in c in the Y-direction are the standard deviation of each FE. The error bars in the X-direction are the standard deviation of IR-corrected potential. Each error bar was calculated from three independent measurements. FIG. 4D depicts the correlation between A-(hkl) and FEs at ˜−0.99 to −1.00 V (RHE), (e) Stability test of A-CuNW catalysts at corrected potentials ranging from ˜−0.97 to ˜−1.07 V (RHE).

FIGS. 5A, 5B, 5C, 5D, 5E, and 5F provide the stability and activity of Cu(511) step surface. FIG. 5A depicts the surface phase diagram of Cu(100) and Cu(511) ([3(100)×(111)]) for 0 ML, 1 ML H and the highest stabilized H coverages as a function of potentials at pH 7. FIG. 5B depicts the magnified view of the yellow box in FIG. 5A. FIG. 5C depicts the CO, and 2CO adsorption energies (ΔG_{ads}) on Cu(100) and Cu(511), The CO+* represents CO and an active site on the surface before the adsorption of CO; the CO* represents the active site with CO adsorption. FIG. 5D depicts the C1 and C2 pathway on Cu(100) and Cu(511). Transition states for C2 pathway are depicted in FIG. 5E for Cu(100) and FIG. 5F for Cu(511). Orange, grey, red, and white balls stand for Cu, C, O, and H, respectively.

FIGS. 6A, 6B, and 6C. FIG. 6A depicts the PXRD of Syn-CuNWs. FIG. 6B depicts the size of Syn-CuNWs. The size was determined by averaging more than 100 NWs. FIG. 6C depicts the PXRD of polycrystalline Cu-foil.

FIGS. 7A, 7B, 7C, 7D, 7E, and 7F. FIG. 7A depicts the highly stepped surface of A-CuNWs after the activation process. FIG. 7B depicts the FFT on parts of A-CuNW. FIGS. 7C and 7D depict the HRTEM images of the surface of A-CuNW. FIG. 7E depicts the [n(001)×(011)] steps on the surface of A-CuNW. FIG. 7F depicts the [n(100)×(111)] on the surface of A-CuNW.

FIGS. 8A and 8B. FIG. 8A depicts the SEI of Syn-CuNWs. FIG. 8B depicts the SEI of A-CuNWs.

FIG. 9 provides the Pb under-potential deposition (UPD) of Syn-CuNWs (black line) and A-CuNWs (blue line) to extract ECSA measured in N₂-saturated 0.1 M HClO₄+0.001 MPb(ClO₄)₂ solution at room temperature. The background current (dotted lines) were measured in N₂-saturated 0.1 M HClO₄.

FIGS. 10A and 10B provide the Nyquist plot of Syn-CuNWs (black) and A-CuNWs (blue).

FIG. 11 provides the redox reaction of Syn-CuNWs and A-CuNWs in 0.1 M KOH at 100 mV/s scan rate. Cu(100) at ˜0.362 V, Cu(110) at 0.395-0.43 V, Cu(111) at ˜0.492 V, and A-(hkl) (high energy steps) at a negative shift from Cu(100)).

FIG. 12 provides the OH adsorption of CuNWs after 10 min of activation. Cu(100) at ˜0.362 V (blue color), Cu(110) at 0.395-0.43 V (green color).

FIGS. 13A, 13B, and 13C provides the electrochemical CO₂RR performance from three independent measurements. FIG. 13A depicts the FEs of Cu foil. FIG. 13B depicts the FEs of Syn-CuNW catalysts. FIG. 13C depicts the FEs of A-CuNW catalysts. Different sizes of the shape indicate different batches of CO₂RR tests.

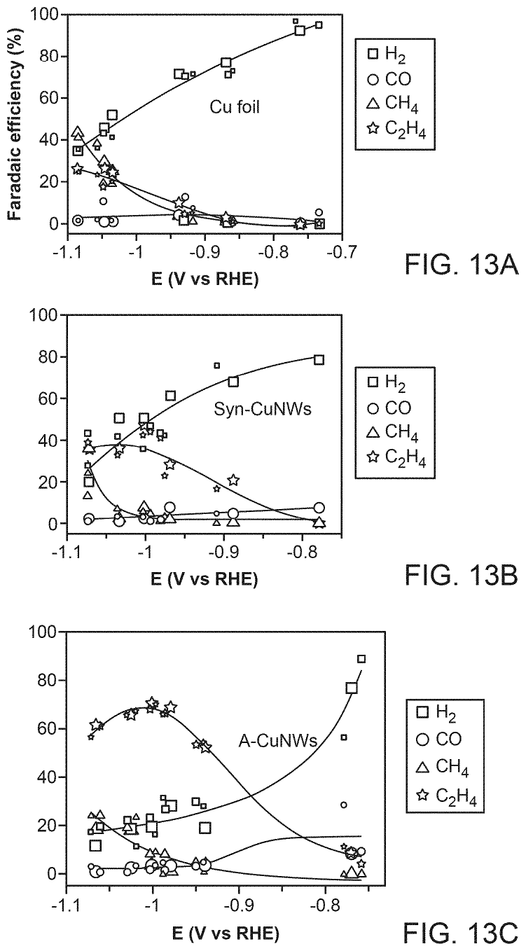

FIGS. 14A, 14B, 14C, and 14D provides the partial current density of Syn-CuNW and A-CuNW catalysts for each product: C₂H₄ (FIG. 14A), CO (FIG. 14B), CH₄ (FIG. 14C), and H₂, (FIG. 14D).

FIGS. 15A and 15B. FIG. 15A depicts the surface roughness factor (SRF) of commercial-Cu nanoparticles and A-CuNWs. FIG. 15B depicts the FEs for commercial-Cu nanoparticles. The SRF was calculated from CV of electrochemical double-layer from 152 to 202 mV by changing scan rates.

FIG. 16 provides the stability of Cu foil at −1.07 V in 0.1 M KCHO₃.

FIG. 17 provides the stability test of A-CuNW catalysts at potential ranging from −0.98 to −1.07 V (RHE) for 198 hours. Top axis indicates corrected potential.

FIGS. 18A, 18B, 18C, and 18D. FIG. 18A depicts the correlation between A-(hkl) and FE_{C2H4} over the long-term stability test (x-axis is broken at 2.1 h, 0-1.5 h correspond to activation period). FIG. 18B depicts the correlation of both A-(hkl) and FEs with activation times at −0.99 V-−1.00 V (RHE). FIG. 18C depicts the correlation of both A-(hkl) and FEs with activation times at −1.05 V-−1.07 V (RHE). FIG. 18D depicts the correlation of A-(hkl) and FE_{C2H4} including data points from stability tests (indicated by solid red stars).

FIGS. 19A, 19B, 19C, 19D, 19E, and 19F. FIG. 19A depicts the low magnification SEI of A-CuNW catalysts after CO₂RR for 205 h. FIGS. 19B and 19C show high magnification SEI of A-CuNW catalysts after CO₂RR for 205 h. FIG. 19D depicts the OH adsorption of CuNWs after CO₂RR for 24 h. FIG. 19E depicts OH adsorption of CuNWs after CO₂RR for 50 h. FIG. 19F depicts OH adsorption of CuNWs after CO₂RR for 205 h. Cu(100) at ˜0.362 V (blue color), Cu(110) at 0.395-0.43 V (green color), and A-(hkl) (high energy steps_red color) at a negative shift from Cu(100).

FIG. 20 provides the H* binding energies of eight possible binding sites on Cu(511). Cu atoms on the step are indicated by red.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Described herein are copper based electrochemical catalysts for the reduction of CO₂ to hydrocarbons, such as ethylene. These catalysts are Cu nanowires having a stepped surface. The stepped surface includes Cu(100) terraces adjacent to Cu(111) steps, where the terraces are formed in an axial direction and the steps are present as planes on a side surface of a Cu nanowire. The catalysts described herein are stable, highly active, and have high product selectivity for ethylene in the electrochemical reduction of CO₂.

Specifically, as further discussed in more detail in the Examples, the copper based catalysts described herein exhibit remarkably high Faradaic efficiency (FE) for C₂H₄ (77.4±3.16%) and this high FE_{C2H4} can be maintained for 205 hr at 61-72%. These copper based catalysts are Cu nanowires (NWs) that have rich surface steps, including Cu(100) terraces next to Cu(111) steps. Computation studies revealed that the Cu nanowires have a Cu(511) (S-[3(100)×(111)]) stepped surface, which strongly favors C2 products by suppressing C1 pathway compared to Cu(100) and is also thermodynamically favored under operating conditions.

In one aspect, is a catalyst including Cu nanowires (CuNWs), wherein the Cu nanowires include a stepped surface. CuNWs are prepared in accordance to previously reported procedures and typically display 5-fold twin with {110} axial direction and {100} side facets. These synthesized CuNWs (Syn-CuNWs) may be collected by centrifuge and washed five times with a hexane/ethanol mixture and are characterized in the Examples. The surface steps are generated by subjecting the Syn-CuNW to an electrochemical activation environment that are similar to that of the CO2RR (e.g., under a high reduction bias (V=−1.05 V) in 0.1 M KHCO₃ electrolyte solution for over 30 minutes). After this electrochemical activation, the activated CuNWs (termed A-CuNWs) showed highly uneven surfaces and are characterized in the Examples.

In some embodiments, the Cu nanowires (or activated CuNWs) include a Cu(511) plane ([3(100)×(111)]) stepped surface. In some embodiments, the stepped surface includes Cu(100) terraces adjacent to Cu(111) steps, where the terraces are formed in an axial direction and the steps are present as planes on a side surface of a Cu nanowire.

As discussed in the Examples, the electrochemical surface area (ECSA) activated CuNWs described herein are higher that that of the synthesized CuNWs. In some embodiments, the Cu nanowires (or activated CuNWs) have an electrochemical surface area (ECSA) of greater than 1.68 m²/g or greater than 1.7 m²/g, including greater than 1.7 m²/g, greater than 1.8 m²/g, greater than 1.9 m²/g, greater than 2.0 m²/g, greater than 2.1 m²/g, greater than 2.2 m²/g, greater than 2.3 m²/g, greater than 2.4 m²/g, and grater than 2.5 m²/g. In some embodiments, the Cu nanowires have an electrochemical surface area (ECSA) of about 2.9 m²/g to about 3.5 m²/g, including about 2.9 m²/g, about 3.0 m²/g, about 3.1 m²/g, about 3.2 m²/g, about 3.3 m²/g, about 3.4 m²/g, and about 3.5 m²/g In some embodiments, the Cu nanowires have an electrochemical surface area (ECSA) of about 3.0 m²/g to about 3.1 m²/g, including about 3.01 m²/g, about 3.02 m²/g, about 3.03 m²/g, about 3.04 m²/g, about 3.05 m²/g, about 3.06 m²/g, and about 3.07 m²/g. In some embodiments, the Cu nanowires have an electrochemical surface area (ECSA) of about 3.07 m²/g or about 3.1 m²/g.

After electrochemical activation of the Cu nanowires, the resulting activated CuNWs have highly uneven surfaces. In some embodiments, the Cu nanowires (or activated CuNWs) have a surface roughness factor (SRF) of less than 18, including less than 17, less than 16, less than 15, less than 14, less than 13, and less than 12. In some embodiments, the Cu nanowires have a surface roughness factor (SRF) of about 10 to about 18, including about 11 to about 18. In some embodiments, the Cu nanowires have a surface roughness factor (SRF) of about 10, about 11, about 12, about 13, about 14, about 15, about 16, about 17, or about 18. In some embodiments, the Cu nanowires have a surface roughness factor (SRF) of less than 17.86. In some embodiments, the Cu nanowires have a surface roughness factor (SRF) of about 11.35 or about 11.

The Cu nanowires described herein are electrochemically activated in order to generate the surface steps. The conditions for activating the Cu nanowires are similar to that of the CO₂RR, i.e. under a high reduction bias (V=−1.05 V) in 0.1 M KHCO₃ electrolyte solution for over 1 hour. Specifically, a gas-tight electrolysis H-Cell separated with the Nafion ion exchange membrane may be used. Before loading onto the working electrode with a pipette, the CuNWs may be mixed with ethanol, ultrasonicated, further mixed with Nafion, and ultrasonicated. The working electrode, which is coated with the Cu NWs, may be a L-type glassy-carbon electrode (e.g. diameter: 5 mm, area: 0.196 cm²). A Pt coil may be used as a counter electrode. The reference electrode may be 4 M KCl Ag/AgCl electrode.

Also provided in one aspect is a method of making Cu nanowires with a stepped surface, including
preparing Cu nanowires; and
applying an electrical current under a high reduction bias thereby forming the stepped surface on the Cu nanowires.

Also provided in another aspect is a method of making Cu nanowires with a stepped surface (or activated CuNWs), including:
preparing Cu nanowires; and
applying an electrical current under a high reduction bias thereby forming the stepped surface on the Cu nanowires;
wherein the stepped surface includes Cu(100) terraces adjacent to Cu(111) steps, where the terraces are formed in an axial direction and the steps are present as planes on a side surface of a Cu nanowire.

In some embodiments, the high reduction bias is from about −0.75 V to about −1.5 V, including about −0.75 V, about −0.8 V, about −0.85 V, about −0.9 V, about −0.95 V, about −1.0 V, about −1.1 V, about −1.2 V, about −1.3 V, about −1.4 V, or about −1.5 V. In some embodiments, the high reduction bias is about −1.05 V or about −1.1 V.

As described in the Examples, the Cu nanowires (or activated CuNWs) described herein may be used as electrochemical catalysts for the reduction of CO₂ to provide hydrocarbons. The setup for electrochemical CO₂RR are similar to the conditions and setup used to generate the surface steps, where a gas-tight electrolysis H-Cell. KHCO₃ (e.g. 0.1 M KHCO₃) or a suitable bicarbonate may be used as the electrolyte solution. Before CO₂RR, CO₂ (Air gas, 99.99%) is bubbled for an appropriate amount of time (e.g. 30 min) to reach saturation. During CO₂RR, cathodic compartment may be purged with CO₂ (e.g., at 15 sccm with stirring a stir bar (1200 rpm) during CO₂RR.

Also provided in one aspect is a method of reducing CO₂, including
contacting CO₂ with a catalyst comprising Cu nanowires, wherein the Cu nanowires comprise a stepped surface and
applying an electrical current sufficient to reduce the CO₂.

Also provided in another aspect is a method of reducing CO₂, including:
contacting CO₂ with a catalyst including Cu nanowires (or activated CuNWs), wherein the Cu nanowires comprise a stepped surface; and
applying an electrical current sufficient to reduce the CO₂ to form a hydrocarbon, such as ethylene;
wherein the stepped surface includes Cu(100) terraces adjacent to Cu(111) steps, where the terraces are formed in an axial direction and the steps are present as planes on a side surface of a Cu nanowire.

The Cu nanowires described herein (or activated CuNWs) demonstrate remarkably high Faradaic efficiency (FE) for C₂H₄ (e.g. 77.4±3.16% at −1.01±0.01 V (RHE)). In some embodiments, the method provides C₂H₄ at a selectivity of at least 50%. In some embodiments, the method provides C₂H₄ at a selectivity of at least 70%. In some embodiments, the method provides C₂H₄ at a selectivity of at least 55%, at least 60%, at least 65%, at least 70%, at least 75%, at least 80%, at least 85%, at least 90%, or at least 95%. In some embodiments, the method provides C₂H₄ at a selectivity of about 55%, about 60%, about 65%, about 70%, about 75%, about 80%, about 85%, about 90%, or about 95%. In some embodiments, the method provides C₂H₄ at a selectivity of from about 50% to about 85%, from about 55% to about 85%, from about 60% to about 85%, or from about 60% to about 80%.

The Cu nanowires described herein (or activated CuNWs) are also stable (e.g. about 200 hours in H-cells). In some embodiments, the Cu nanowires have a stability of greater than 10 hours, greater than 25 hours, greater than 50 hours, greater than 75 hours, greater than 100 hours, greater than 125 hours, greater than 150 hours, greater than 175 hours, or greater than 200 hours. In some embodiments, the Cu nanowires have a stability of about 10 hours, about 25 hours, about 50 hours, about 75 hours, about 100 hours, about 125 hours, about 150 hours, about 175 hours, or about 200 hours. In some embodiments, the Cu nanowires have a stability of from about 10 hours to about 250 hours, from about 10 hours to about 200 hours, from about 25 hours to about 250 hours, from about 25 hours to about 200 hours, from about 75 hours to about 250 hours, from about 75 hours to about 200 hours, from about 100 hours to about 250 hours, or from about 100 hours to about 200 hours.

In some embodiments, the method is performed in a H-cell. In some embodiments, the Cu nanowires are coated on an electrode.

The present invention, thus generally described, will be understood more readily by reference to the following examples, which are provided by way of illustration and are not intended to be limiting of the present invention.

### EXAMPLES

### Example 1

### Highly Active and Stable Stepped Cu Surface for Enhanced Electrochemical CO₂ Reduction to C₂H₄

Electrochemical CO₂ reduction to value-added chemical feedstocks is of considerable interest for renewable energy storage and renewable source generation while mitigating CO₂ emission from human activity. Copper represents an effective catalyst in reducing CO₂ to hydrocarbons or oxygenates, but is often plagued by the low product selectivity and limited long-term stability. Here we report that Cu nanowires with rich surface steps exhibit remarkably high Faradaic efficiency (FE) for C₂H₄ that can be maintained for over 200 hours. Computational studies reveal that these steps are thermodynamically favored compared to Cu(100) under operating conditions and the stepped surface favors C2 products by suppressing C1 pathway and hydrogen production.

Developing highly-efficient electrocatalysts for the carbon dioxide reduction reaction (CO₂RR) to value-added fuels and chemicals offers a feasible pathway for renewable energy storage and could help mitigate the ever-increasing CO₂ emission from human activities. Several metal electrodes are known to catalyze CO₂RR in aqueous solutions. Among all catalysts explored to date, copper (Cu) is the only electrocatalytic material that converts CO₂ to hydrocarbons products with significant activity and efficiency. Additionally, due to Cu's natural abundance and low cost, it has been intensively studied for CO₂RR for decades. However, the low product selectivity towards valuable fuel products and the lack of long-term stability remain major challenges for Cu based catalysts. Various approaches have been explored to address these challenges. For example, Kanan and coworkers reported that the grain boundaries on Cu film and surface defects promote productions of hydrocarbons with one-carbon (C1 product) (˜45% CO at −0.5 V and ˜33% HCO₂H at −0.65 V vs. reversible hydrogen electrode (RHE), referenced to all potentials in this article unless otherwise specified). Moreover, residual surface copper oxides have been suggested to enhance the production of hydrocarbons with two carbons (C2).

Among major gaseous products, ethylene (C₂H₄) is desirable since it is a basic building block to produce various plastics, solvents, and cosmetics. In 2020 alone, 158 million tons of C₂H₄ global market is estimated, and the annual demand for ethylene is expected to grow ˜4.5% through 2027. However, the selective production of C₂H₄ from CO₂RR is challenging, with competition from the hydrogen evolution reaction (HER) and methane (CH₄) production. It has been predicted and shown with single-crystal studies that the formation of specific surface step sites on Cu catalysts can lower the barrier for CO dimerization to promote C2 productions over C1 products. Indeed, Cheng et al. performed a thorough density functional theory (DFT) screening of active defect sites for electrochemical CORR to C2 products at grain boundaries of Cu nanoparticles. They found that the most active surface sites for C2 productions on grain boundaries consist of one strong CO binding site next to one weak CO binding site, significantly reducing the energy of the *OCCHO transition state, making it active towards C2 products. Nature of the active sites for CO reduction on copper nanoparticles; suggestions for optimizing performance. J. Am. Chem. Soc. 139, 11642-11645 (2017).

Herein, we report the preparation of Cu nanowires (CuNWs) with highly active stepped surface through in-situ electrochemical activation of pregrown CuNWs with {100} surface. The electrochemical CO₂RR studies demonstrate remarkably high C2 selectivity with Faradaic efficiency toward ethylene (FE_{C2H4}>70%), as well as exceptionally high stability for ˜200 hours. The high ethylene selectivity is attributed to the unique surface structure of the CuNWs with abundant stepped sites. Our DFT studies showed that the Cu(511) plane [3(100)×(111)] stepped surface is thermodynamically favored at CO₂RR conditions over either Cu(100) or Cu(111) under operating conditions, explaining the experimentally observed long-term stability. The calculations also revealed a higher barrier for C1 path, along with slower HER on Cu(511) and compared to C2, leading to the greatly enhanced selectivity towards C₂H₄.

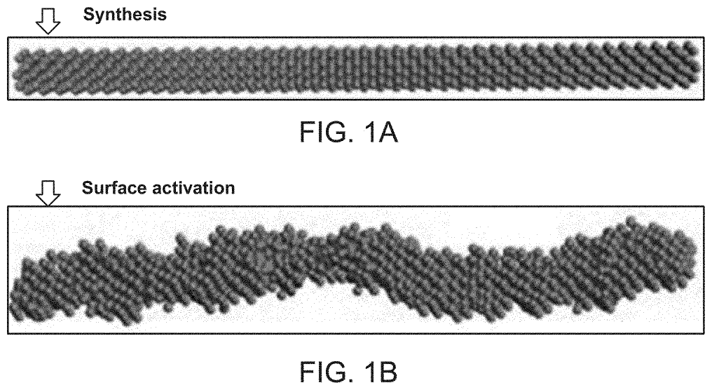

FIGS. 1A and 1B provide a schematic of preparing the CuNWs with surface steps as described herein. FIG. 1A depicts the as-synthesized CuNWs with {100} surface. FIG. 1B depicts that the CuNWs is activated in situ during the electrochemical CO₂RR to form surface steps.

Preparation of CuNWs with Surface Steps

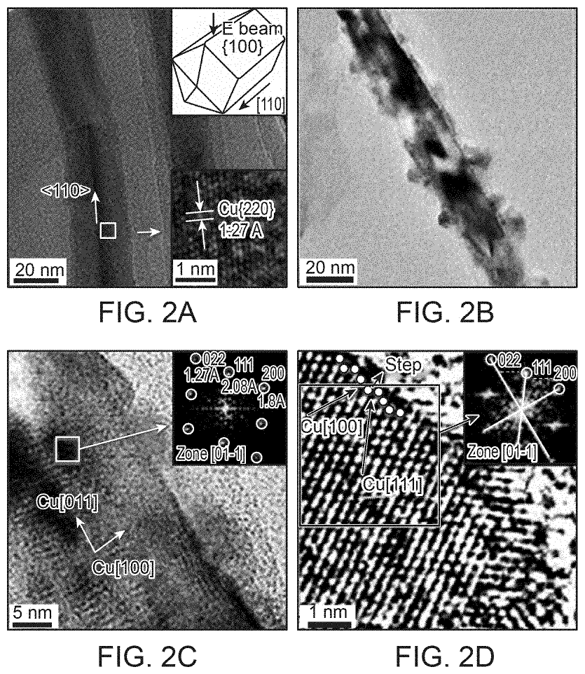

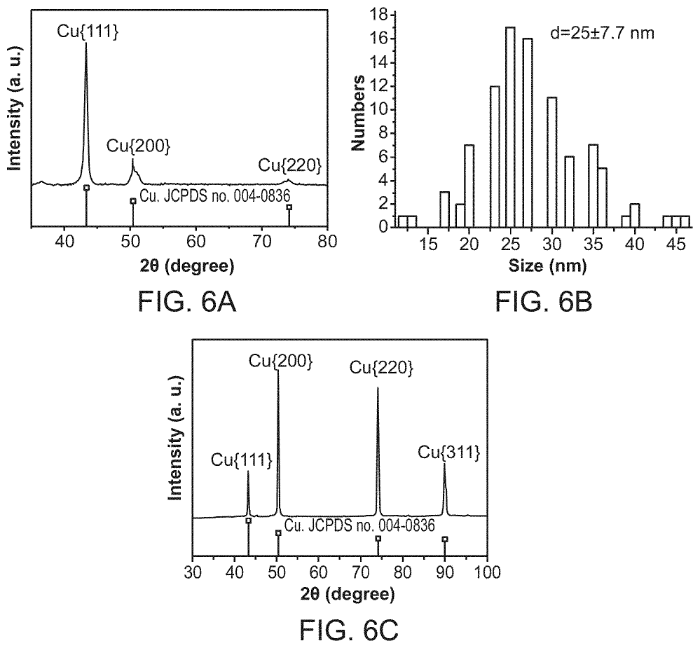

The CuNWs were synthesized with a protocol similar to previously reported approach (Angew. Chem. Int. Ed. Engl. 50, 10560-10564 (2011)), with the resulting NWs typically displaying 5-fold twin with <110> axial direction and {100} side facets (see Methods for details). The synthesized CuNWs (termed Syn-CuNWs) were collected by centrifuge and washed five times with hexane/ethanol mixture. The structure of Syn-CuNWs was characterized by powder X-ray diffraction (PXRD), transmission electron microscopy (TEM), secondary electron imaging (SEI). The PXRD peaks of Syn-CuNWs match those of the Cu (FIG. 6A). The low resolution TEM image of the Syn-CuNWs demonstrates its one-dimensional wire structure with a smooth surface (FIG. 2A) and an average diameter of 25 nm ±7.7 nm (FIG. 6B). The high resolution TEM (HRTEM) of the Syn-CuNW (FIG. 2A inset) shows a 1.27 Å lattice spacing of Cu{220} and the Cu<110> direction, which is consistent with the expected <110> axial growth direction of the Syn-CuNWs.

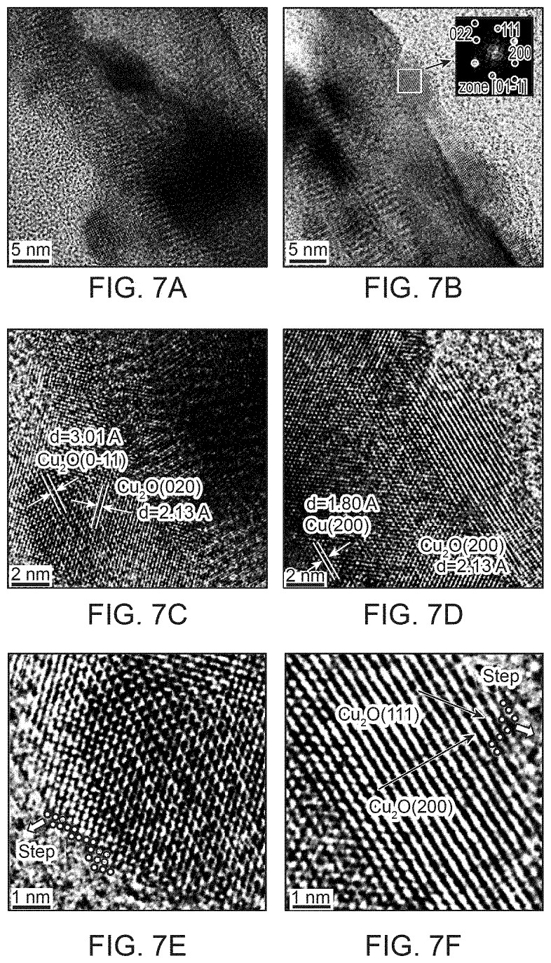

To generate surface steps, the Syn-CuNWs were subjected to electrochemical activation environment similar to that of the CO₂RR, i.e. under a high reduction bias (V=−1.05 V) in 0.1 M KHCO₃ electrolyte solution for over 30 minutes. After this electrochemical activation, the activated CuNWs (termed A-CuNWs) showed highly uneven surfaces (FIG. 2B). The HRTEM of A-CuNWs after one hour activation showed zone [011] of FFT spots. The plane spacing in the zone [011] of FFT spots shows 2.08 Å, 1.80 Å, 1.27 Å, which indexed as Cu{111}, Cu{200} and Cu{220}, respectively (FIGS. 2C and 2D). Both Cu₂O and Cu phase were found on A-CuNW surface with the <110> axial direction and <100> towards sides suggesting {100} rich side surface (FIG. 2C and FIGS. 7A-7F). The Cu₂O observed in HRTEM on the surface of A-CuNWs was likely due to the instant surface oxidation after removing the reduction potential, which will convert back to Cu under applied reduction potentials ˜−0.8-−1.1 V. The HRTEM images on A-CuNW surface also indicated the formation of surface steps, with some in the form of [n(100)×m(111)] (FIG. 2D and FIGS. 7A-7F).

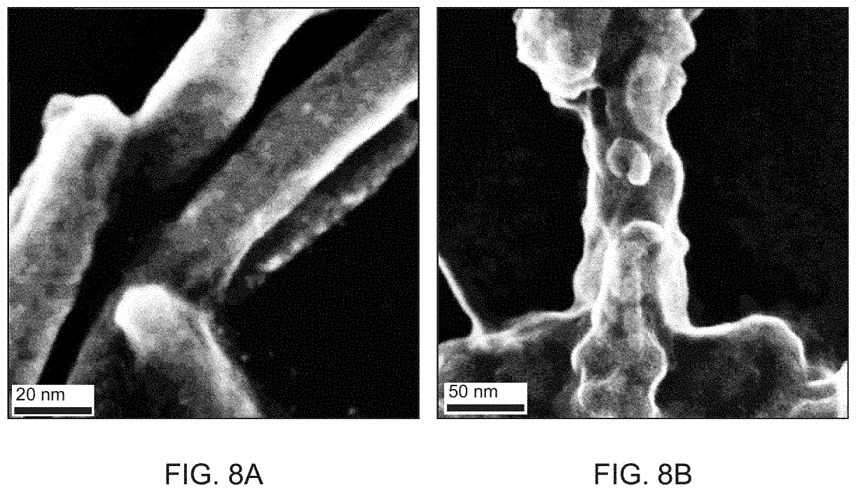

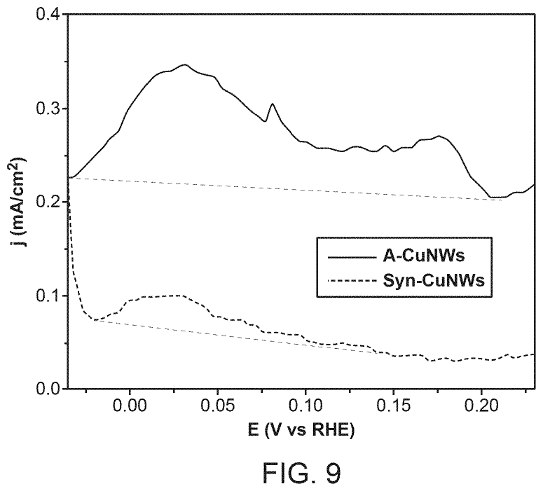

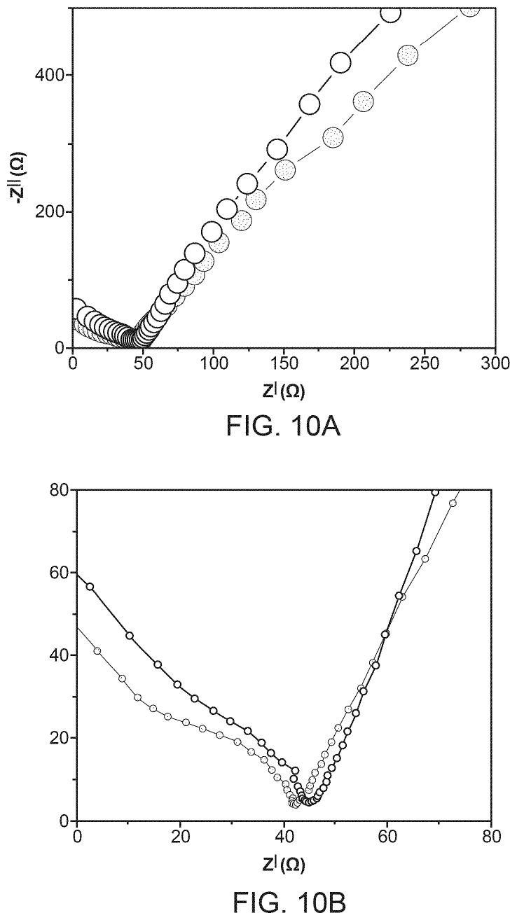

In addition, secondary electron imaging (SEI) in scanning transmission electron microscopy (STEM) mode also confirmed pronounced roughened/stepped topology of the A-CuNWs compared to Syn-CuNWs (FIGS. 8A and 8B). We further performed lead (Pb) under potential deposition (Pb-UPD) (FIG. 9) which revealed that the electrochemical surface area (ECSA) of the A-CuNWs (3.07 m²/g) was higher than that of the Syn-CuNWs (1.68 m²/g). Thus, the electrochemical surface activation process produced A-CuNWs with stepped surfaces and with increased ECSA. Moreover, electrochemical impedance spectroscopy (EIS) showed that the A-CuNWs show slightly lower ohmic resistance (42 Ω) than that of the Syn-CuNWs (45Ω) (FIGS. 10A and 10B).

### Electrochemical Characterization of CuNW Surfaces

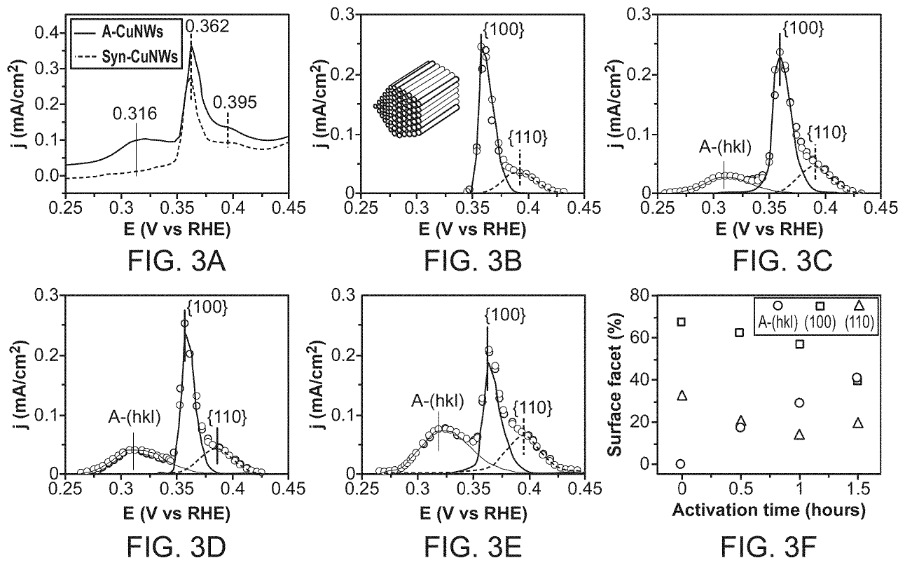

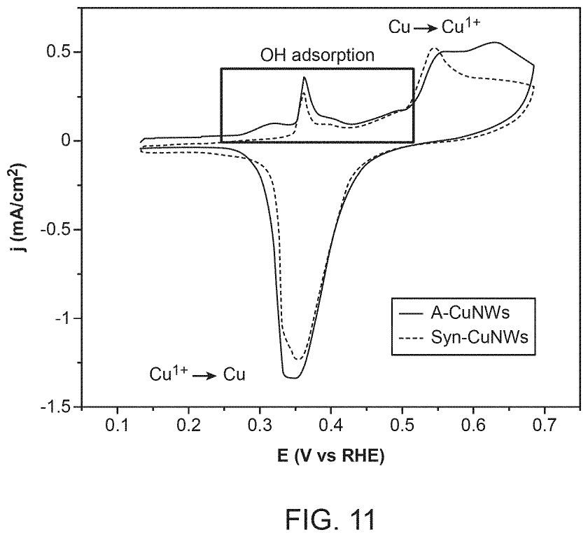

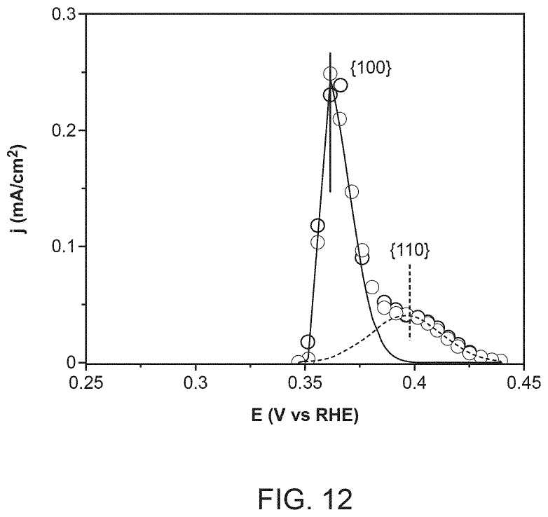

To further evaluate the surface features of the CuNWs, we examined OH⁻ adsorption spectra on the catalyst surface through the Cu⇄Cu₂O redox reaction cyclic voltammetry (CV) (see Methods for details) (FIG. 11). The Syn-CuNWs showed OH⁻ adsorption peaks at 0.362 V and 0.395 V (FIG. 3A), corresponding to Cu(OH)ad on Cu{100} and Cu{110}, respectively. In particular, the most pronounced Cu(OH)_{ad} adsorption peak at 0.362 V corresponds well with the expected Cu{100} facet on the Syn-CuNW surface. Interestingly, compared to Syn-CuNWs, one additional OH⁻ adsorption peak emerged at 0.316 V (FIG. 3A) on A-CuNWs. This additional peak (assigned here to A-(hkl)) appeared at a more negative potential than those of the low index facets of Cu, indicating stronger OH⁻ adsorption, which had been assigned to Cu surfaces with high-energy steps. For example, Raciti et al. reported an OH⁻ adsorption peak (˜0.34 V) with a negative shift from Cu{100} peak (˜0.36 V), which they assigned to Cu(211) ([3(111)×(100)]). DFT calculations of Cu—O binding energy by Tian et al. also reported that the stepped surface of Cu(311) ([2(100)×(111)]) led to stronger Cu—O binding energy compared with Cu(100) and Cu(111). To gain a more quantitative evaluation of surface facet evolution, we estimated the percentage of the surface planes on Syn-CuNWs and A-CuNWs by integrating each OH_{ad} peaks after subtracting the background (FIGS. 3B, 3C, 3D, 3E and FIG. 12). Syn-CuNW surface comprised of mostly Cu{100} (67%) and Cu{110} (32%) (FIG. 3B), consistent with the NW structure whose side facets are mostly {100} with some {110} (schematic in FIG. 3B). Compared to Syn-CuNWs (FIG. 3B), A-CuNWs showed increasing percentage of A-(hkl) with prolonged activation time from 0% (0 h), 17% (0.5 h), 28% (1 h) to 41% (1.5 h) (FIG. 3F). Meanwhile, Cu{100} and Cu{110} reduced from 67% to 39% and from 32% to 19%, respectively (FIG. 3F and Table 3). These observations suggest that the {100} and {110} expressed on Syn-CuNW surface gradually transformed into the higher energy A-(hkl) surface structures during the electrochemical activation process, which is consistent with the TEM observations (FIG. 2).

### Electrochemical CO₂RR Evaluation

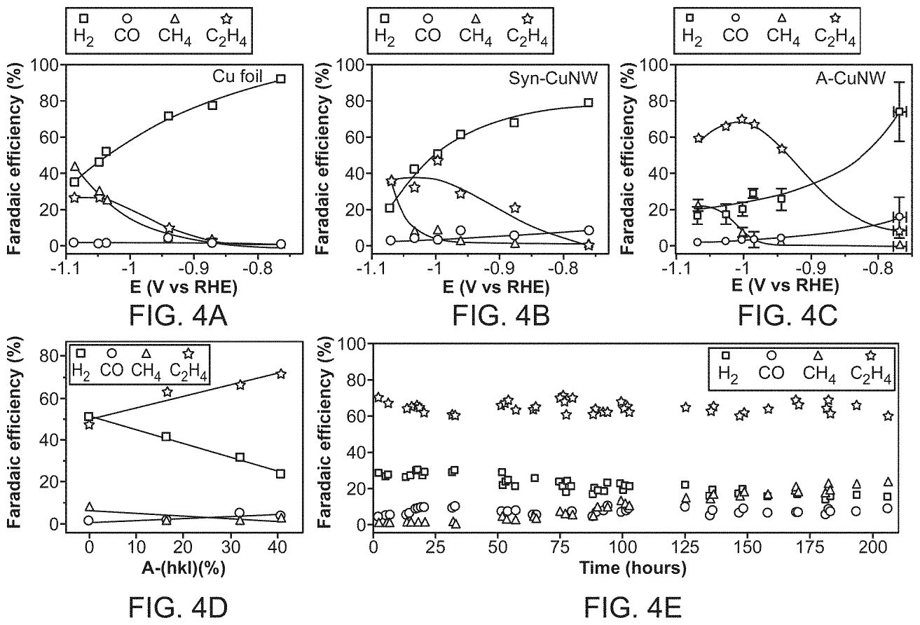

We studied the CO₂RR performance of CuNW catalysts with a gas-tight H cell by analyzing effluent gas and liquid products at different applied potentials between −0.75 and −1.1 V in CO₂-saturated 0.1 M KHCO₃ (pH 6.8), at room temperature and under atmospheric pressure. The current density and ECSA of the CuNWs were evaluated using the rotating disk electrode (RDE), the CO₂RR performances were evaluated in H-cell coupled with Gas Chromatography Barrier Ionization Discharge (GC-BID) (see the Methods for details). The performance of the A-CuNW catalysts was compared to that of the commercial Cu foil and Syn-CuNWs, respectively (FIGS. 4A, 4B, and 4C). Because most of the products from CO₂RR on our catalysts were in the gas phase, we focus our discussions of CO₂RR performances on gas-phase products (Tables 4-6). First of all, we observed that the A-CuNWs (with one hour activation) showed a considerably higher yield of C₂H₄ with an average peak FE_{C2H4} of 69.79±1.44% around −1.00 V (FIG. 4C, Table 4), when compared with the Syn-CuNWs (FE_{C2H4}=44.65±2.20%) (FIG. 4B and Table 5), and the polycrystalline Cu foil (FE_{C2H4}=22.80±4.60%). We note the primary CO₂RR products of the polycrystalline Cu foil were found to be CH₄ (24.67±5.15%) and C₂H₄ (22.80±4.60%) around −1 V (Table 6), which is consistent with previously reported CO₂RR of Cu polycrystalline foil.

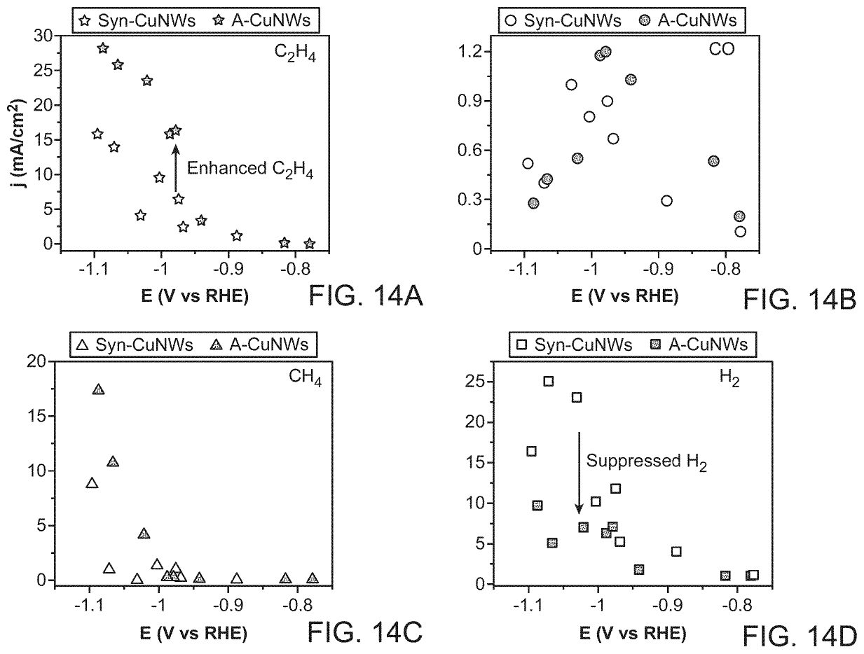

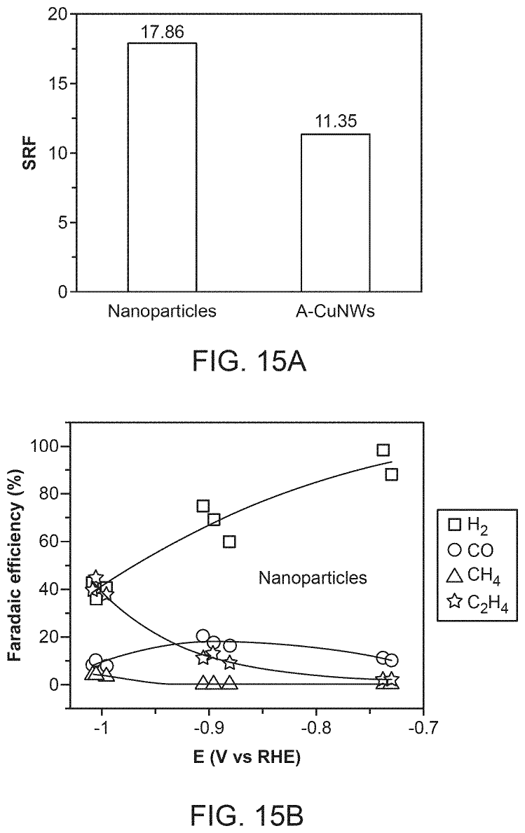

Overall, compared to Syn-CuNWs, the A-CuNWs showed a higher partial current density of FE_{C2H4} and much lower HER partial current density (FIGS. 14A-14D). High surface roughness could lead to enhanced C₂H₄ production, we further compared the FE_{C2H4} between the commercial 25 nm Cu nanoparticles and the A-CuNWs. We found that A-CuNWs showed less surface roughness, while still exhibiting about 30% higher FE_{C2H4} than the commercial 25 nm Cu nanoparticles (37.08±6.87% FE_{C2H4} at −1.00±0.01 V) (FIGS. 15A and 15B), ruling out the likely contribution from sample surface roughness to product selectivity. Hence we tentatively attribute the high C2 H4 selectivity observed in A-CuNWs to its highly stepped surface.

To further confirm the correlation of FE_{C2H4} with the stepped surface structure A-(hkl), we further compared different products from A-CuNW with the different activation duration and thus difference surface portion of A-(hkl). Significantly, a clear correlation was observed between FE_{C2H4} and the value of A-(hkl). Specifically, as the stepped surface A-(hkl) gradually increased from 0% to 40.68%, the FE_{C2H4} increased from 47.04% to 71.19%, correspondingly (FIG. 4D). At the same time, we observed decreasing FE_{CH4} and FE_{H2} with increasing A-(hkl) (FIG. 4D).

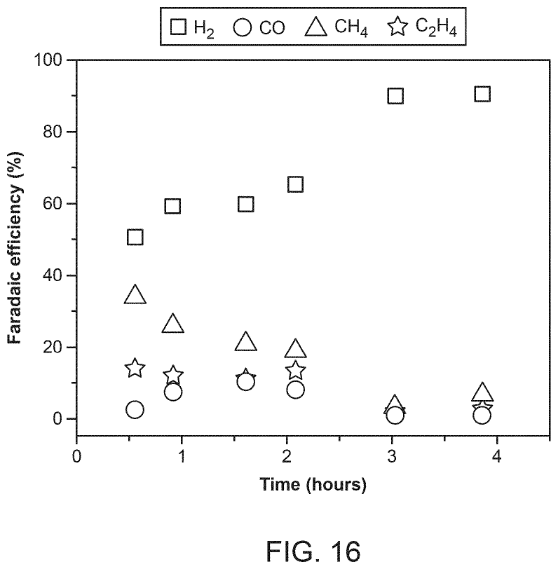

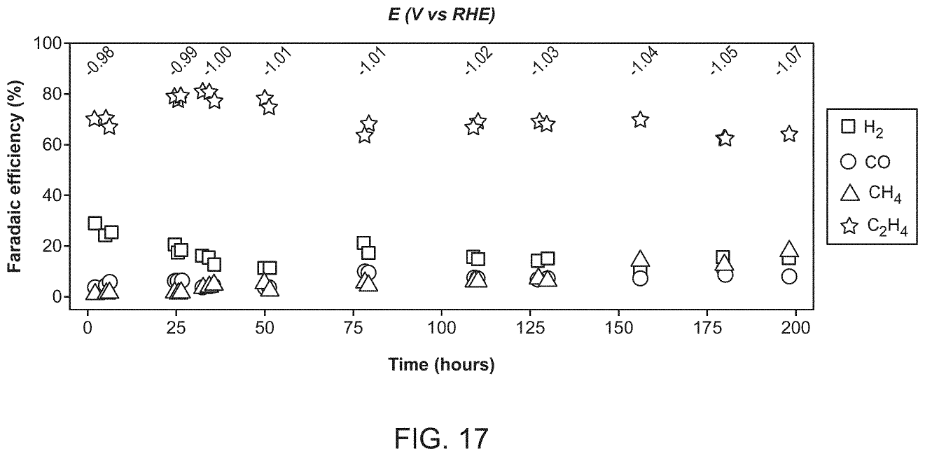

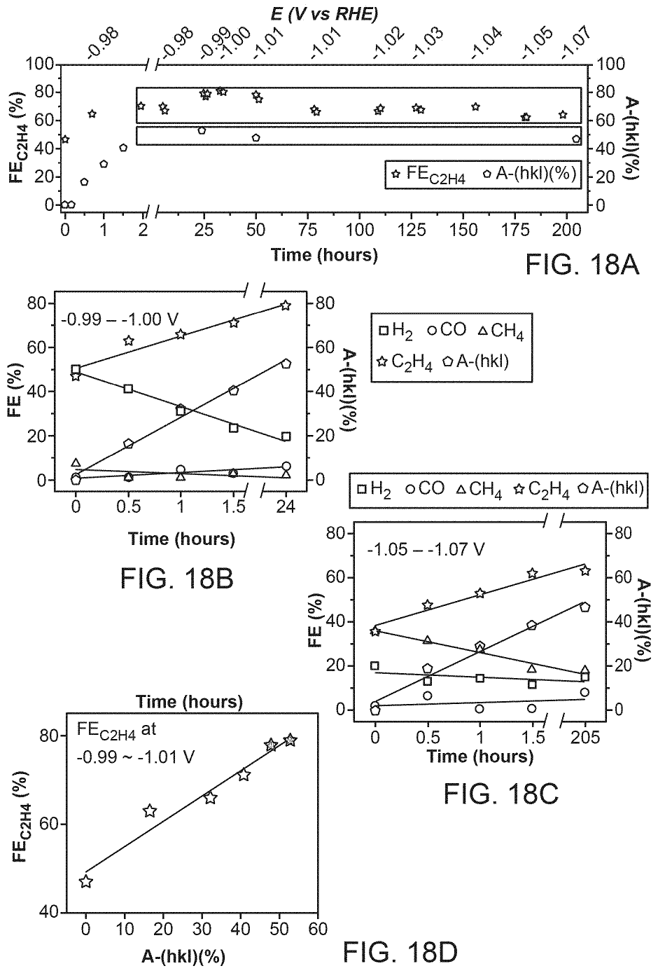

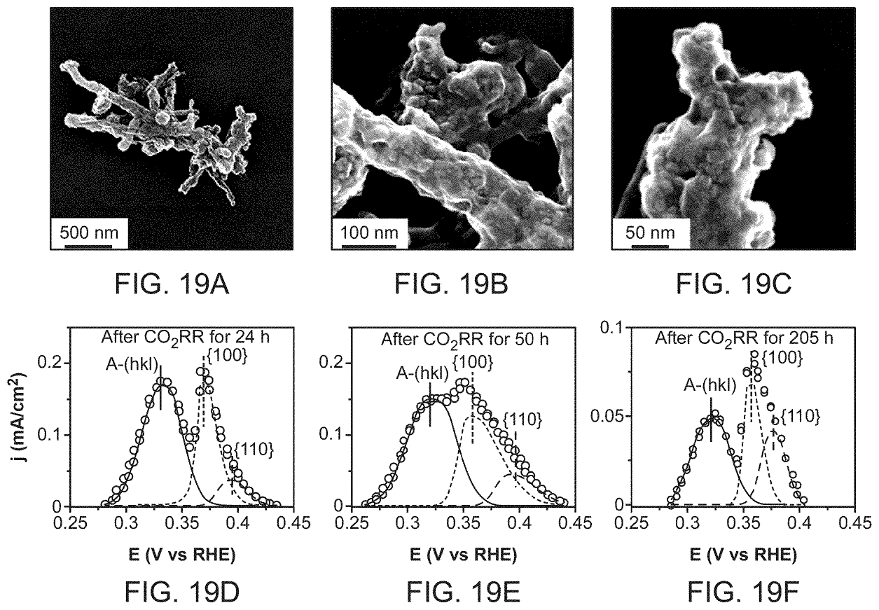

Importantly, these A-CuNWs with stepped surfaces exhibited sustained high CO₂RR performance during the stability test. The A-CuNWs showed stable C₂H₄ production (61%-72% FE_{C2H4}) for 205 hours at the corrected potentials ranging from −0.97 to −1.07 V) (FIG. 4E). In comparison, the Cu foil showed only less than 2-hour stability with ˜20-34% FE_{CH4} at −1.07 V (FIG. 16). A repeated stability test lasting 198 hours further confirmed the sustainable high performance of A-CuNWs with 64%-79% FE_{C2H4} (FIG. 17). The sustained high FE_{C2H4} suggested the high stability of the A-(hkl) surface steps on A-CuNWs. Indeed, the OH_{ad} spectra of A-CuNWs showed that the A-(hkl) portion remained at a stable range within 45.40±5.62% for ˜200 hours after the initial activation period (˜1.5 hours) (FIG. 18A). We also observed that during the stability test, the A-(hkl) continued to increase slightly with the ongoing CO₂RR after the initial 1.5 hours of activation, correspondingly led to a further increase in FE_{C2H4}. The highest FE_{C2H4} (79%) was hence achieved around 24 h into the reaction during the stability test, corresponding to A-(hkl) around 50% (FIG. 17). Averaging 16 FE_{C2H4} collected from stability test at potential around −1 V, we obtained a remarkably high FE_{C2H4} of ˜77.40±3.16% (Table 1). Additionally, the SEI images confirmed that the A-CuNWs retained its 1D morphology and the stepped surface topology after the long term stability test (FIGS. 19A-19F). Together, the A-CuNWs demonstrated remarkably high FE_{C2H4} while maintaining its exceptional stability for 200 hours' continuous operation in H-cell (Table 1 and Table 7).

TABLE 1
Comparison of CO₂RR in peak C₂H₄ production for different Cu-based catalysts in H-cells.
The FE_{C2H4} of A-CuNWs was averaged from 16 measurements in the stability tests.

| | Applied | | | | CO₂ | |
|---|---|---|---|---|---|---|
| | potentials V | J_{C2H4} | Max | | Flow rate | |
| Catalysts | (RHE) | mA/cm2 | FE_{C2H4} | Electrolyte | (sccm) | Source |
| A-CuNWs | −1.01 ± 0.01 | ~17.3 | 77.40 ± 3.16% | 0.1M KHCO₃ | 15 | This work |
| Cu | −0.95 | 11.2 | 45% | 0.1M KHCO₃ | 20 | (43) |
| Nanocube | | | | | | |
| (250-300 nm) | | | | | | |
| Cu | ~−0.86 | 6.7 | 33% | 0.1M KHCO₃ | 20 | (44) |
| Nanocube | | | | | | |
| (10-40 nm) | | | | | | |
| Plasma | −0.90 | 7.2 | 60% | 0.1M KHCO₃ | 30 | (14) |
| treated Cu | | | | | | |
| foil | | | | | | |
| Electro- | −1.20 | 22.2 | 38% | 0.1M KHCO₃ | 20 | (45) |
| ReDeposited- | | | | | | |
| Cu | | | | | | |
| Branched | −1.05 | ~17.0 | ~70% | 0.1M KHCO₃ | 60 | (46) |
| CuO NPs | | | | | | |
| Cu-based | −1.10 | ~10.0 | 57% | 0.1M KHCO₃ | 20 | (47) |
| NPs | | | | | | |

### DFT Studies of Surface Stability and Activity

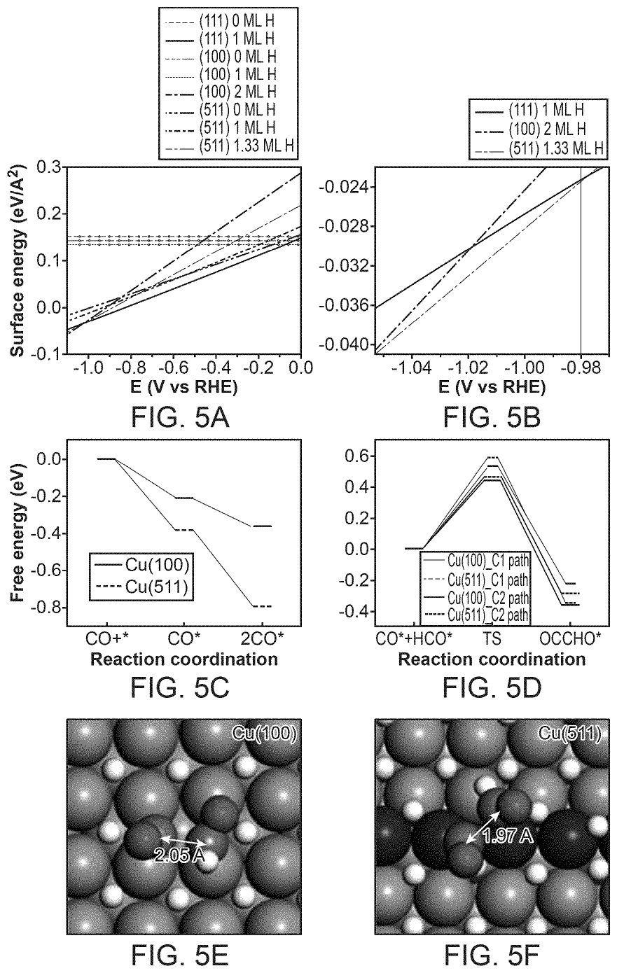

The observation of long term stability of the high-index A-(hkl) surface is rather counter intuitive and intriguing, as high-energy surface steps were generally believed to be less stable than the low-index ones. To this end, we sought to assess the stability of the stepped surface under the working conditions. We performed grand canonical DFT calculations based on the Cu(S)-[n(100×m(111)] stepped surface to construct the surface phase diagram. FIGS. 5A and 5B show the surface energies for Cu(100), Cu(111) and Cu(511) ([3(100)×(111)]) as a function of RHE potential. On Cu(100), we found one monolayer (ML) hydrogen (H) for U <−0.07 V and 2 ML H for U<−0.83 V for equilibrium H coverage (θ_{H}). On Cu(511), we found 1 ML H for U<−0.10 V, 1.33 ML H for U<−0.74 V and that further increase of H* would evoke a severe surface reconstruction. On Cu(111), 1 ML H (U<−0.08 V) is the maximum coverage, which allows local minimum of H* without any imaginary frequency. At U=−0.98-−1.06 V, Cu(511) with θ_{H}=1.33 has the lowest surface energy compared with the Cu(100) with θ_{H}=2 and Cu(111) with θ_{H}=1 in FIGS. 5A and 5B. Therefore, we expect that once the stepped surface is formed, there is no driving force to reconstruct back to the flat Cu(100) surface at working potential, which provides good stability for the stepped surfaces.

TABLE 2
CO adsorption energies (ΔG_{ads}), kinetic barriers (ΔG^{‡}) and
free energy changes (ΔG) for C1, C2 pathways by 1 ML of H*.

| | 1CO* | 2CO* | HCO* → HCOH* | | CO* + HCO* → OCCHO* | |
|---|---|---|---|---|---|---|
| | ΔG_{ads} | ΔG_{ads} | ΔG^{‡} | ΔG | ΔG^{‡} | ΔG |
| Cu(100) | −0.21 eV | −0.36 eV | 0.53 eV | −0.22 eV | 0.44 eV | −0.36 eV |
| Cu(511) | −0.38 eV | −0.80 eV | 0.59 eV | −0.34 eV | 0.46 eV | −0.28 eV |

We also calculated CO adsorption free energies to verify if the stepped surface is beneficial for CO adsorption since the CO population is a key factor for C2+ products. We found that the step on Cu(511) leads to 0.17 eV higher affinity for a single CO adsorption compared to Cu(100) as shown in Table 2. Moreover, the two adjacent molecular CO adsorption can occur cooperatively, which is 0.44 eV more stable on the step sites on Cu(511) compared to Cu(100) where c(2×2)-CO adlayer structure was observed in an operando STM study (37). Therefore, we confirmed that the step on Cu(511) can secure a higher local CO surface population, and that this facet is also favorable for two adjacent CO adsorptions, which is beneficial for C—C coupling.

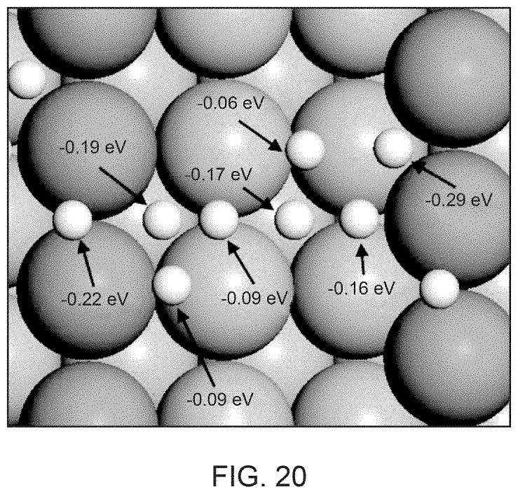

Next, we performed DFT to explain the reaction kinetics. The OCCHO* intermediate is an important intermediate toward production of C2 products, especially at higher overpotentials, while the HCO* intermediate can branch out to form either HCOH* for the C1 pathway or OCCHO* for the C2 pathway. We calculated the reaction energy barriers (Δ [symbol] ) and reaction free energies (ΔG) for each pathway, as shown in Table 2. The frequency contributions are listed (Table 8). To calculate the kinetic barrier for the protonation of HCO* intermediate into HCOH*, we introduced a surface water molecule as a proton source at pH 6.8. The reduction of HCO* to HCOH* occurs with Δ [symbol] =0.53 eV on Cu(100) and Δ [symbol] =0.59 eV on Cu(511), respectively. Therefore, Cu(511) has 0.06 eV higher reaction barrier from HCO* to HCOH*, making it ˜10 times slower than that on the Cu(100) at 298 K. On the other hand, despite the high stability of the 2CO* configuration, the kinetic barrier for C—C coupling from CO*+HCO* toward OCCHO* (C2 pathway) on Cu(511) is only 0.02 eV higher compared to that on Cu(100), making it only 2 times slower than that on Cu(100). We also performed DFT calculations for hydrogen binding energy (HBE) on Cu(100), and on various adsorption sites on Cu(511) to estimate HER activity based on the fact that low HER activity for Cu has been attributed to its weak HBE (40). Compared to the HBE of −0.31 eV on Cu(100), Cu(511) showed even smaller HBEs ranging from −0.06 eV to −0.29 eV on various binding sites (FIG. 20), indicating the suppression of HER on Cu(511).

Thus, we suggest that the high local population of 2CO*,the higher barrier for the C1 path on Cu(511) and the slower HER are the key underlying factors for the enhancement in C2 production observed on A-CuNWs. These results are all consistent with the experimental observations that increasing surface ratio of stepped surface A-(hkl) led to increasing FE_{C2H4}, decreasing FE_{CH4} and FE_{H2} (FIG. 4D and FIGS. 18B, 18C). In addition, the stronger OH⁻ adsorption on A-CuNWs can also induce longer H₂O adsorption residence time on the surface of Cu, leading to the preference of hydrocarbon products (e.g. ethylene) over alcohol products (e.g. ethanol), which share a common intermediate with ethylene. This is consistent with the observed low ethanol production for A-CuNW catalysts (Table 4).

### Discussion

In conclusion, we have reported here that CuNW catalysts with the highly stepped surface exhibit high FE_{C2H4} (77.40±3.16%) that is stable for ˜200 hours in H-cells. Coupled with structural and electrochemical surface characterizations of A-CuNWs, our DFT calculations showed that the stepped surface [3(100)×(111)]) exhibits a high local population of 2CO* and a higher barrier for the C1 path compared to Cu(100), leading to higher product selectivity towards C₂H₄. These findings suggest an effective approach to engineer catalyst surfaces for high reactivity, high selectivity, and high stability under operando conditions.

### Methods

Chemicals. Copper(II) chloride dihydrate (CuCl₂.2H₂O, 99.999%), D-(+)-Glucose (>99.5%), Hexadecylamine(HDA) (>98%), Ethanol (200 proof), 25 nm Cu NPs were all purchased from Sigma-Aldrich. Potassium hydroxide (KOH) and Hexane (99.9%) were purchased from Fisher Chemical. All chemicals were used without purification. Ultra-pure purification system (Milli-Q advantage A10) produced the DI water (18.2 MΩ/cm) used in making solutions. The 99.9% Cu foil from Metal Remnants, Inc. cut to 1 cm², and mechanically polished by 400G sandpaper from 3M and electrochemically polished in 85% phosphoric acid under −1 V (RHE) for 5 min. The Cu foil was subsequently rinsed with DI water and used for CO₂RR.

Preparation of CuNW catalysts. In a typical synthesis of CuNW catalysts, 22 mg CuCl₂.2H₂O, 50 mg D-(+)-Glucose, 180 mg HDA were pre-dissolved in 10 mL DI water in 30 mL vial. The chemical solution was mixed in the sonication for 15 min and then transferred to an oil bath. The mixture was heated from room temperature to 100° C. for 8 h and cooled to room temperature. The synthesized CuNWs were washed five times with sonication in hexane/ethanol (1:1 volume) solvent for 20 min. The CuNWs were collected by centrifuge at 9500 rpm.

Materials characterizations. Hexane dispersion of catalysts was dropped and dried onto carbon-coated copper TEM grids (Ted Pella, Redding, Calif.) under room temperature to prepare TEM samples. The FEI CM120 TEM at 120 kV was used for low resolution TEM images. The FEI Titan TEM operating at 300 kV was used to take HRTEM. Dark field scanning TEM image was taken by JEM-ARM300F Grand ARM TEM at 300 kV. Scanning electron microscopy (SEM) images were taken by Nova Nano 230, and SEI was taken by JEOL 2800 TEM with 200 kV. The size of CuNWs was measured by the largest diameter within the CuNWs. The size was determined by averaging more than 100 NWs. A Panalytical X'Pert Pro X-ray Powder Diffractometer with Cu—Kα radiation was used for PXRD patterns. ICP-AES (TJA RADIAL IRIS 1000) was conducted to determine the metal concentration in the catalysts used.

Electrode preparation and collecting data for calculation of FE. 4 mg of dried CuNWs was mixed with 1 mL ethanol and ultrasonication for 1 h. Subsequently, 10 μL of Nafion (5 wt. %) was added and kept ultrasonication for an extra 10 min. 10 μL of the catalysts ink was dropped onto electrodes using a pipette and dried under ambient air. The 10 μL of the catalysts ink contained 0.04 mg Cu, which was measured by ICP-AES.

To activate CuNW catalysts and measure FE, a gas-tight electrolysis H-Cell (WizMac) separated with the Nafion ion exchange membrane (Sigma Aldrich) was used. The working electrode coated with catalysts was an L-type glassy-carbon electrode (diameter: 5 mm, area: 0.196 cm²) from WizMac. The Pt coil from Pine Instruments was used as a counter electrode. The 4 M KCl Ag/AgCl electrode from Pine Instruments was used as a reference electrode. The impedance of each solution was tested on a Princeton VersaSTAT 4 electrochemistry workstation. After IR correction, all discussed potentials were converted to those against RHE.

The 0.1 M KHCO₃ electrolyte solution was used for every electrochemical CO₂RR. Before CO₂RR, we bubbled CO₂ (Air gas, 99.99%) for 30 min to reach saturation, and we kept purging CO₂ into the cathodic compartment at 15 sccm with stirring a stir bar (1200 rpm) during CO₂RR. The activation of CuNW catalysts was conducted with chronoamperometry (CA) in CO₂-saturated 0.1 M KHCO₃ solution at −1.05 V (RHE) for 1 h. We measured FE by using CA for 30-40 min at each applied potential except for the Syn-CuNW catalysts. The FEs of Syn-CuNW catalysts were measured in 10 min to prevent any activation of CuNW catalysts (FIG. 12). For the long-term stability test, the CO₂ saturated 0.1 M KHCO₃ electrolyte was replaced every 12 h and applied pulse potentials (˜−0.97 V (RHE) for 600 s and 0.32 V (RHE) for 10 s) to remove possible surface poisoning from the produced formate. The FEs was measured roughly every 2-3 h during the stability test except for during the night shift. The stability test was performed at room temperature and under atmospheric pressure.

Gas Product Analysis was done with a Shimadzu Tracera Gas Chromatography Barrier Ionization Discharge (GC-BID) 2010 Plus (Shimadzu) equipped with a Restek Micropacked GC column. The standard curve of GC-BID was calibrated by five standard gases (Air gas). The carrier gas was Helium (Air gas, 99.9999%). A p-type Hastelloy 6 port sampling loop (1.5 mL) was directly routed to an outlet gas line of gas-tight H cell. 1.5 mL effluence gas was analyzed with the Shimadzu Tracera GC-BID 2010 Plus.

The FE was calculated as below:

$${FE}_{J} = \frac{{nFvjGp}_{0}}{{RT}_{0} {i}_{total}} \times 100 \% \qquad ( 1 )$$

where:

n=the number of electrons for a given product.

V_{J} (vol. %)=the volume concentration of gas products (CO, H₂, CH₄, and C₂H₄) in the effluence gas from the electrochemical cell (GC data)

G (ml/min at room temperature and ambient pressure)=Gas flow rate measured by a ProFlow 6000 electronic flow meter (Restek) at the exit of the electrochemical cell

iₜₒₜₐₗ (mA)=steady-state cell current

p₀=1.01×105 Pa, T₀=298.15 K, F=96485 C•mol⁻¹, R=8.314 J•mol⁻¹•K⁻¹

Quantitative NMR (Bruker AV-600) was conducted to analyze the liquid product. Specifically, 0.3 mL of D₂O was added to 0.65 mL of the reacted electrolyte, and 50 μL of dimethyl sulfoxide (0.512 μM/mL) was also mixed as an internal standard. The 1D ¹H spectrum was measured with a pre-water saturation method.

Electrochemical measurements. Before we carried out OH_{ad} on CuNWs, the CuNWs on the L-type glassy carbon electrode was activated in H-cell with CO₂ saturated 0.1 M KHCO₃ by purging CO₂ gas. Then, the catalysts on the L-type glassy carbon electrode were transferred to a three-electrode cell.

For OH⁻ adsorption _{reaction}, we conducted OH⁻ adsorption reaction CV in 0.1 M KOH at 100 mV/s scan rate with Hg/HgO reference electrode (CH Instrument). The OH⁻ adsorption reaction is described accurately by one electron process as follows.³³

Cu*+OH⁻⇄Cu*(OH)_{ad}+e⁻ (2)

Cu+OH⁻⇄Cu(OH)_{ad}+e⁻ (3)

To calculate the number of OH⁻ adsorptions on each Cu planes on the CV scan, the linear background was subtracted.³⁰ We integrated currents corresponding to the assigned Cu{100} facets, Cu{110} facets, Cu{111} facets, and A-(hkl) by each peak scan time as follows;

$$\frac{\int IdV}{v \times e} = The numbers of OH adsorption of Cu facets \qquad ( 4 )$$

### Where:

I (C/s)=the current under OH⁻ absorption peak corresponding to each Cu facets

dV (V)=voltage of each Cu facets, ν (V/s)=scan rate of OH⁻ adsorption CV scan, e=electric charge (1.602×10¹⁹ C)

For the total current densities and ECSA measurement, the three-electrode cell was used. The working electrode was a glassy-carbon RDE (diameter: 5 mm, area: 0.196 cm²) from Pine Instruments coated with catalysts. The graphite rod was used as the counter electrode. The double junction Ag/AgCl (the inner filling 4 M KCl and the outer filling 10% KNO₃) electrode from Pine Instruments was the reference electrode. The total current densities were measured from CV scans between 0 V to −1.1 V (RHE) at 50 mV/s with rotating RDE at 1200 rpm in CO₂ saturated 0.1 M KHCO₃. Subsequently, the ECSA of the CuNWs was measured by Pb UPD. The background current was measured in N₂-saturated 0.1 M HClO₄ between 0.26 V to −0.38 V (RHE) at 10 mV/s. In N₂-saturated 0.1 MHClO₄+0.001 M Pb(ClO₄)₂ solution at room temperature, the ECSA was carried out by subtracting the background current from the integrated Pb desorption charge on the CV between 0.26 V to −0.38 V (RHE) at 10 mV/s. A conversion factor of 310 μC/cm² is based on a monolayer of Pb adatoms coverage over Cu and 2e⁻ Pb oxidation.

Computational details for Cu(100) and Cu(511). The quantum mechanics (QM) calculations were carried out using the VASP software at the version of 5.4.4, with the Perdew, Burke, and Ernzerhof (PBE) flavor of DFT. The projector augmented wave (PAW) method (Phys. Rev. B 59, 1758 (1999)) was used to account for core-valence interactions. The kinetic energy cutoff for plane wave expansions was set to 500 eV, and reciprocal space was sampled by the Monkhorst-Pack scheme with a grid of 3×3×1 and 2×3×1 for Cu(100) and Cu(511), respectively. The vacuum layer is at least 20 Å above the surface. The convergence criteria are 1×10⁻⁵ eV energy differences for solving the electronic wave function. The Methfessel-Paxton smearing of second order with a width of 0.1 eV was applied. All geometries (atomic coordinates) were converged to within 0.03 eV Å⁻¹ for maximal components of forces. A post-stage vdW DFT-D3 method with Becke-Jonson damping was applied (J. Chem. Phys. 132, 154104 (2010)). The solvation was treated implicitly using the VASPsol method (J. Chem. Phys. 140, 084106 (2014)).

We employed CI-NEB method (J. Chem. Phys. 113, 9978 (2000)) with five images to find potential energy surface along with the reaction coordinates, and the subsequent dimer method was applied near the saddle point to find the transition state until force converges <0.01 eV/Å. All transition state has only one imaginary frequency.

All Gibbs free energy includes vibrational contributions of zero-point energy, enthalpy, and entropy. To compare all surfaces, we normalized the Gibbs free energy to its surface area. The Gibbs free energies were calculated at 298 K and 1 atm as outlined in:

G=H−TΔS=E_{DFT}+E_{ZPE}+Eₛₒₗᵥ+∫₀²⁹⁸Cᵥ dT−TΔS (5)

Where E_{DFT} is the DFT-optimized total energy, E_{ZPE} is the zero-point vibrational energy, Eₛₒₗᵥ is the solvation energy. ∫₀²⁹⁸Cᵥ dT is the heat capacity, T is the temperature, and ΔS is the entropy.

For surface phase diagram, Gibbs free energy change is calculated at 298 K, pH 7 as outlined:

ΔG_{surf}=G_{surf-sol}−G_{bulk-sol}−NG_{H2O-sol}+n(½G_{H}_{₂}^{O}+k_{B}^{T} ln a_{H}_{⁺}−eU) (6)

Where G is the Gibbs free energy, k_{B} is the Boltzmann constant, T is the temperature, a_{H+} is the proton activity, U is an applied potential.

Electrochemical CO₂ reduction to value-added fuels and feedstocks offers solutions to the shortage of renewable energy sources while remediating CO₂ emission from human activity. Copper (Cu) is effective at reducing CO₂ to hydrocarbons or oxygenates, but low product selectivity and short production stability impede practical applications. We report here that Cu nanowires (NWs) displaying rich surface steps, including Cu(100) terraces next to Cu(111) steps, demonstrate remarkably high (77.4±3.16%) Faradaic efficiency (FE) for C₂H₄ at −1.01±0.01 V (RHE) and that this high FE_{C2H4} can be maintained for 205 hr. at 61˜72%. Computational studies reveal that the Cu(511) (S−[3(100)×(111)]) stepped surface strongly favors C2 products by suppressing C1 pathway compared to Cu(100) and that the stepped surface is thermodynamically favored under operating conditions.

### Conclusions

The CuNWs were synthesized with a protocol similar to the previously reported approach (FIG. 2A). To generate surface steps, synthesized CuNWs (termed Syn-CuNWs) were subjected to electrochemical activation environments similar to that of the CO₂RR, i.e. under a high reduction bias (V=−1.05 V) in 0.1 M KHCO₃ electrolyte solution for over 1 hour. After this electrochemical activation, the activated CuNWs (termed A-CuNWs) showed highly uneven surfaces (FIG. 2B).

The OH⁻ adsorption spectra on the catalyst surface showed the generation of high energy surface step. OH⁻ adsorption peaks at 0.362 V and 0.395 V of Syn-CuNWs (FIG. 3A) corresponded to Cu(OH)_{ad} on Cu{100} and Cu{110}, respectively. Interestingly, compared to Syn-CuNWs, one additional OH⁻ adsorption peak emerged at 0.316 V (FIG. 3A) on A-CuNWs. This additional peak (assigned here to A-(hkl)) appeared at a more negative potential than those of the low index facets of Cu, indicating stronger OH⁻ adsorption, which had been assigned to Cu surfaces with high-energy steps. The calculated percentage of the surface planes on Syn-CuNWs and A-CuNWs by integrating each OH_{ad} peaks showed increasing percentage of A-(hkl) with prolonged activation time from 0% (0 h), 17% (0.5 h), 28% (1 h) to 41% (1.5 h) (FIG. 3F). Meanwhile, Cu{100} and Cu{110} reduced from 67% to 39% and from 32% to 19%, respectively.

We performed DFT calculations based on the Cu(511) ([3(100)×(111)]) stepped surface. The step on Cu(511) leads to 0.17 eV higher affinity for a single CO adsorption compared to Cu(100) as shown in Table 2. Moreover, the two adjacent molecular CO adsorption can occur cooperatively, which is 0.44 eV more stable on the step sites on Cu(511) compared to Cu(100). We also calculated the reaction energy barriers (Δ [symbol] ) and reaction free energies (ΔG) for each C1 and C2 pathway, as shown in Table 2. Cu(511) has 0.06 eV higher reaction barrier from HCO* to HCOH* for C1 pathway, making it ˜10 times slower than that on the Cu(100) at 298 K. On the other hand, despite the high stability of the 2CO* configuration, the kinetic barrier for C—C coupling from CO*+HCO* toward OCCHO* (C2 pathway) on Cu(511) is only 0.02 eV higher compared to that on Cu(100), making it only 2 times slower than that on Cu(100). We also performed DFT calculations for hydrogen binding energy (HBE) on Cu(100), and on various adsorption sites on Cu(511) to estimate HER activity based on the fact that low HER activity for Cu has been attributed to its weak HBE. Compared to the HBE of −0.31 eV on Cu(100), Cu(511) showed even smaller HBEs ranging from −0.06 eV to −0.29 eV on various binding sites, indicating the suppression of HER on Cu(511). Thus, we suggest that the high local population of 2CO*,the higher barrier for the C1 path on Cu(511) and the slower HER are the key underlying factors for the enhancement in C2 production observed on A-CuNWs.

TABLE 3
The surface portions of OH_{ad} on each facet of all catalysts.

| Reaction Time | | A-(hkl) (%) | Cu{100} (%) | Cu{110} (%) |
|---|---|---|---|---|
| Before | | 0 | 67.49 | 32.50 |
| 10 | min | 0 | 73.83 | 26.16 |
| 30 | min | 17.03 | 62.38 | 20.57 |
| 1 | h | 28.98 | 57.16 | 13.85 |
| 1.5 | h | 41.12 | 39.50 | 19.37 |
| 205 | h | 46.82 | 31.58 | 21.58 |

TABLE 4
FEs for A-CuNWs. Each point was averaged, and the standard deviation
was calculated from three independent measurements.

| V (RHE) | H₂ % | CO % | CH₄ % | C₂H₄ % | Ethanol % | Acetate % | Formate % | Total % |
|---|---|---|---|---|---|---|---|---|
| −0.76 ± | 74.11 ± | 15.56 ± | 0 | 8.10 ± | 0 | 0 | 1.53 | 99.32 ± |
| 0.01 | 16.37 | 11.16 | | 3.52 | | | | 4.44 |
| −0.94 ± | 25.60 ± | 4.05 ± | 3.19 ± | 53.62 ± | 0 | 0 | 1.51 | 87.98 ± |
| 0.00 | 5.74 | 0.98 | 1.87 | 1.09 | | | | 6.61 |
| −0.98 ± | 28.82 ± | 3.35 ± | 3.18 ± | 67.14 ± | 1.50 | 0 | 0.73 | 104.75 ± |
| 0.00 | 2.33 | 1.47 | 4.40 | 1.56 | | | | 0.73 |
| −1.00 ± | 19.90 ± | 3.05 ± | 7.09 ± | 69.79 ± | 2.61 | 1.35 | 0.43 | 104.24 ± |
| 0.00 | 3.39 | 1.11 | 2.71 | 1.44 | | | | 1.55 |
| −1.06 ± | 16.30 ± | 1.65 ± | 22.22 ± | 59.95 ± | 3.39 | 0 | 0.24 | 103.77 ± |
| 0.00 | 4.16 | 1.28 | 3.26 | 2.82 | | | | 6.78 |

TABLE 5
FEs for Syn-CuNWs. Each Point was averaged, and the standard
deviation was calculated from three independent measurements.

| V (RHE) | H₂ % | CO % | CH₄ % | C₂H₄ % | Total % |
|---|---|---|---|---|---|
| −0.89 ± 0.01 | 63.59 ± 15.01 | 4.25 ± 0.97 | 0 | 22.05 ± 6.02 | 89.90 ± 9.92 |
| −0.97 ± 0.00 | 49.02 ± 10.61 | 4.35 ± 3.06 | 2.18 ± 1.24 | 30.76 ± 9.43 | 86.32 ± 13.64 |
| −1.00 ± 0.00 | 44.39 ± 7.62 | 2.23 ± 0.98 | 6.09 ± 1.49 | 44.65 ± 2.20 | 97.38 ± 10.09 |
| −1.03 ± 0.00 | 51.03 ± 9.74 | 1.84 ± 1.49 | 4.29 ± 2.45 | 34.48 ± 1.75 | 91.92 ± 7.93 |
| −1.07 ± 0.00 | 30.44 ± 11.94 | 1.76 ± 0.69 | 24.43 ± 11.27 | 37.25 ± 1.84 | 93.90 ± 3.00 |

TABLE 6
FEs for Cu foil. Each point was averaged, and the standard deviation
was calculated from three independent measurements

| V (RHE) | H₂ % | CO % | CH₄ % | C₂H₄ % | Ethanol % | Acetate % | Formate % | Total % |
|---|---|---|---|---|---|---|---|---|
| −0.75 ± | 94.89 ± | 2.04 ± | 0 | 0 | 0 | 2.08 | 4.79 | 103.81 ± |
| 0.01 | 2.26 | 2.95 | | | | | | 3.82 |
| −0.86 ± | 73.87 ± | 1.51 ± | 0.95 ± | 2.17 ± | 0 | 1.68 | 2.91 | 83.12 ± |
| 0.00 | 3.17 | 1.40 | 0.62 | 1.09 | | | | 3.73 |
| −0.93 ± | 77.87 ± | 6.76 ± | 2.42 ± | 6.74 ± | 0.31 | 0.46 | 2.39 | 96.96 ± |
| 0.00 | 11.82 | 5.17 | 1.22 | 2.73 | | | | 8.13 |
| −1.04 ± | 46.96 ± | 4.36 ± | 24.67 ± | 22.80 ± | 0.91 | 0.18 | 0.65 | 100.53 ± |
| 0.00 | 4.49 | 5.59 | 5.15 | 4.60 | | | | 6.71 |
| −1.07 ± | 35.59 ± | 1.67 ± | 40.97 ± | 24.81 ± | 0.89 | 0.09 | 0.22 | 104.25 ± |
| 0.01 | 0.62 | 0.25 | 2.49 | 1.38 | | | | 3.03 |

TABLE 7
Summary of stability of C₂H₄ production in H-cell.

| | Applied | | Reported | | CO₂ | |
|---|---|---|---|---|---|---|
| | potential V | Stable | Duration | | Flow rate | |
| Catalysts | (RHE) | FE_{C2H4} | (hours) | Electrolyte | (sccm) | Source |
| A-Cu NWs | −0.97-−1.07 | 61-72% | 205 | 0.1M KHCO₃ | 15 | This work |
| A-Cu NWs | −0.98-−1.07 | 64-79% | 198 | 0.1M KHCO₃ | 15 | This work |
| Cu | −0.95 | 45% | 1 | 0.1M KHCO₃ | 20 | (43) |
| Nanocube | | | | | | |
| (250-300 nm) | | | | | | |
| Cu | −0.75 | ~32% | 10 | 0.1M KHCO₃ | 20 | (44) |
| Nanocube | | | | | | |
| (10-40 nm) | | | | | | |
| Plasma | −0.9 | 60% | 5 | 0.1M KHCO₃ | 30 | (14) |
| treated Cu | | | | | | |
| foil | | | | | | |
| Electro- | −1.2 | 40-45% | 5 | 0.1M KHCO₃ | 20 | (45) |
| redeposited | | | | | | |
| Cu | | | | | | |

TABLE 8
Free energy, frequency, Zero-point energy (ZPE), Enthalpy
(Cv), Entropy of all states in DFT calculations.

| | | | Energy [eV] | Frequency [cm⁻¹] | ZPE [eV] | Cv [eV] | TS [eV] |
|---|---|---|---|---|---|---|---|
| Cu(100) | C1 | IS | −263.645 | 3719.04 | 1.606498 | 0.170446 | 0.232887 |
| | | TS | −262.971 | 3643.092 | 1.473867 | 0.179751 | 0.250323 |
| | | FS | −263.98 | 3716.55 | 1.731384 | 0.179365 | 0.249453 |
| | C2 | IS | −263.878 | 2697.653 | 0.630043 | 0.167448 | 0.253563 |
| | | TS | −263.45 | 2757.024 | 0.613232 | 0.13664 | 0.189569 |
| | | FS | −264.291 | 2751.579 | 0.674542 | 0.148478 | 0.22949 |
| Cu(511) | C1 | IS | −207.912 | 3711.546 | 1.435686 | 0.159278 | 0.221053 |
| | | TS | −207.204 | 3762.022 | 1.348848 | 0.189453 | 0.279913 |
| | | FS | −208.391 | 3759.418 | 1.583465 | 0.156297 | 0.230906 |
| | C2 | IS | −208.175 | 2704.296 | 0.641028 | 0.162215 | 0.24363 |
| | | TS | −207.709 | 2709.244 | 0.617154 | 0.140325 | 0.20639 |
| | | FS | −208.316 | 2813.459 | 0.680842 | 0.122072 | 0.179666 |

### Example Embodiments

Some embodiments include a catalyst comprising Cu nanowires, wherein the Cu nanowires comprise a stepped surface. In some embodiments, the Cu nanowires are coated on an electrode. In some embodiments, the Cu nanowires comprise a Cu(511) plane stepped surface. In some embodiments, the stepped surface of the Cu nanowires is formed by applying an electrical current under a high reduction bias, e.g., in an electrolyte solution.

Some embodiments include a method of making Cu nanowires with a stepped surface, comprising preparing Cu nanowires; and applying an electrical current under a high reduction bias thereby forming the stepped surface on the Cu nanowires. In some embodiments, the stepped surface of the Cu nanowires is formed by applying an electrical current under a high reduction bias, e.g., in an electrolyte solution.

Some embodiments include a method of reducing CO₂, comprising contacting CO₂ with a catalyst comprising Cu nanowires, wherein the Cu nanowires comprise a stepped surface and applying an electrical current sufficient to reduce the CO₂. In some embodiments, the method provides C₂H₄ at a selectivity of at least 50% (e.g., 50%, 55%, 60%, 65%, 70%, or more).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

### REFERENCES

1. Schreier, M. et al. Solar conversion of CO₂ to CO using Earth-abundant electrocatalysts prepared by atomic layer modification of CuO. Nat. Energy 2, 17087 (2017).
2. Hori, Y., Wakebe, H., Tsukamoto, T., & Koga, O. Electrocatalytic process of CO selectivity in electrochemical reduction of CO₂ at metal electrodes in aqueous media. Electrochim. Acta 39, 1833-1839 (1994).
3. Hori, Y., Kikuchi, K. & Suzuki, S. Production of CO and CH₄ in electrochemical reduction of CO₂ at metal electrodes in aqueous hydrogen carbonate solution. Chem. Lett. 14, 1695-1698 (1985).
4. Qiao, J., Liu, Y., Hong, F. & Zhang, J. A review of catalysts for the electro-reduction of carbon dioxide to produce low-carbon fuels. Chem. Soc. Rev. 43, 631-675 (2014).
5. Gawande, M. B. et al. Cu and Cu-based nanoparticles: synthesis and applications in catalysis. Chem. Rev. 116, 3722-3811 (2016).
6. Kim, D., Resasco, J., Yu, Y., Asiri, A. M. & Yang, P. Synergistic geometric and electronic effects for electrochemical reduction of carbon dioxide using gold-copper bimetallic nanoparticles. Nat. Commun. 5, 4948 (2014).
7. Lu, Q. et al. A selective and efficient electrocatalyst for carbon dioxide reduction. Nat. Commun. 5, 3242 (2014).
8. Mistry, H., Varela, A. S., Kuhl, S., Strasser, P. & Cuenya, B. R. Nanostructured electrocatalysts with tunable activity and selectivity. Nat. Rev. Mater. 1, 16009 (2016).
9. Angamuthu, R., Byers, P., Lutz, M., Spek, A. L. & Bouwman, E. Electrocatalytic CO₂ conversion to oxalate by a copper complex. Science 327, 313-315 (2010).
10. Li, Y. et al. Structure-sensitive CO₂ electroreduction to hydrocarbons on ultrathin 5-fold twinned copper nanowires. Nano Lett. 17, 1312-1317 (2017).
11. Cheng, T., Xiao, H. & Goddard III, W. A. Reaction mechanisms for the electrochemical reduction of CO₂ to CO and formate on the Cu (100) surface at 298 K from quantum mechanics free energy calculations with explicit water. J. Am. Chem. Soc. 138, 13802-13805 (2016).
12. Raciti, D., Mao, M., Park, J. H., & Wang, C. Local pH effect in the CO₂ reduction reaction on high-surface-area copper electrocatalysts. J. Electrochem. Soc. 165, F799 (2018).
13. Li, C. W. & Kanan, M. W. CO₂ reduction at low overpotential on Cu electrodes resulting from the reduction of thick Cu₂O films. J. Am. Chem. Soc. 134, 7231-7234 (2012).
14. Mistry, H. et al. Highly selective plasma-activated copper catalysts for carbon dioxide reduction to ethylene. Nat. Commun. 7, 12123 (2016).
15. Choi, C. et al. A highly active star decahedron Cu nanocatalyst for hydrocarbon production at low overpotentials. Adv. Mater. 31, 1805405 (2019).
16. Feng, X., Jiang, K., Fan, S. & Kanan, M. W. Grain-boundary-dependent CO₂ electroreduction activity. J. Am. Chem. Soc. 137, 4606-4609 (2015).
17. Li, C. W., Ciston, J. & Kanan, M. W. Electroreduction of carbon monoxide to liquid fuel on oxide-derived nanocrystalline copper. Nature 508, 504 (2014).
18. Mariano, R. G., McKelvey, K., White, H. S. & Kanan, M. W. Selective increase in CO₂ electroreduction activity at grain-boundary surface terminations. Science 358, 1187-1192 (2017).
19. Favaro, M. et al. Subsurface oxide plays a critical role in CO₂ activation by Cu(111) surfaces to form chemisorbed CO₂, the first step in reduction of CO₂. PNAS 201701405 (2017).
20. Lum, Y. & Ager, J. W. Stability of residual oxides in oxide-derived copper catalysts for electrochemical CO₂ reduction investigated with ¹⁸O labeling. Angew. Chem. Int. Ed. Engl. 57, 551-554 (2018).
21. Ethylene-Global Market Trajectory & Analytics, https://www.researchandmarkets.com/reports/354876/ethylene_global_market_trajectory_an d_analytics (2020).
22. Cheng, T., Xiao, H., & Goddard, W. A. Full atomistic reaction mechanism with kinetics for CO reduction on Cu(100) from ab initio molecular dynamics free-energy calculations at 298 K. PNAS 114, 1795-1800 (2017).
23. Cheng, T., Xiao, H. & Goddard, W. A. Nature of the active sites for CO reduction on copper nanoparticles; suggestions for optimizing performance. J. Am. Chem. Soc. 139, 11642-11645 (2017).
24. Hori, Y., Takahashi, I., Koga, O., & Hoshi, N. Selective formation of C2 compounds from electrochemical reduction of CO₂ at a series of copper single crystal electrodes. J. Phys. Chem. B 106, 15-17, (2002).
25. Jin, M., He, G., Zhang, H., Zeng, J Xie, Z., & Xia, Y. Shape-controlled synthesis of copper nanocrystals in an aqueous solution with glucose as a reducing agent and hexadecylamine as a capping agent. Angew. Chem. Int. Ed. Engl. 50, 10560-10564 (2011).
26. Yang, H. J., He, S. Y., & Tuan, H. Y. Self-seeded growth of five-fold twinned copper nanowires: mechanistic study, characterization, and SERS applications. Langmuir 30, 602-610, (2014).
27. Mandal, L. et al. Investigating the role of copper oxide in electrochemical CO₂ reduction in real time. ACS Appl. Mater. Interfaces 10, 8574-8584 (2018).
28. Baturina, O. A. et al. CO₂ electroreduction to hydrocarbons on carbon-supported Cu nanoparticles. ACS Catal. 4, 3682-3695 (2014).
29. Droog, J. M., & Schlenter, B. Oxygen electrosorption on copper single crystal electrodes in sodium hydroxide solution. J. Electroanal. Chem. 112, 387-390 (1980).
30. De Chialvo, M. G., Zerbino, J. O., Marchiano, S. L., & Arvia, A. J. Correlation of electrochemical and ellipsometric data in relation to the kinetics and mechanism of Cu2O electroformation in alkaline solutions. J. Appl. Electrochem. 16, 517-526 (1986).
31. Raciti, D. et al. Low-overpotential electroreduction of carbon monoxide using copper nanowires. ACS Catal. 7 4467-4472 (2017).
32. Luc, W. et al. Two-dimensional copper nanosheets for electrochemical reduction of carbon monoxide to acetate. Nat. Catal. 1, 423-430 (2019).
33. De Chialvo, M. G., Marchiano, S. L., & Arvia, A. J. The mechanism of oxidation of copper in alkaline solutions. J. Appl. Electrochem. 14, 165-175 (1984).
34. Zhang, S., Kang, P., & Meyer, T. J. Nanostructured tin catalysts for selective electrochemical reduction of carbon dioxide to formate. J. Am. Chem. Soc. 136, 1734-1737 (2014).
35. Tian, F. H., & Wang, Z. X. Adsorption of an O atom on the Cu(311) step defective surface. J. Phys. Chem. B 108, 1392-1395 (2004).
36. Hori, Y., Wakebe, H., Tsukamoto, T., & Koga, O. Adsorption of CO accompanied with simultaneous charge transfer on copper single crystal electrodes related with electrochemical reduction of CO₂ to hydrocarbons. Surf Sci. 335, 258-263 (1995).
37. Baricuatro, J. H., Kim, Y. G., Korzeniewski, C. L., & Soriaga, M. P. Seriatim ECSTM-ECPMIRS of the adsorption of carbon monoxide on Cu(100) in alkaline solution at CO₂-reduction potentials. Electrochem. Commun. 91, 1-4 (2018).
38. Resasco, J. et al. Promoter effects of alkali metal cations on the electrochemical reduction of carbon dioxide. J. Am. Chem. Soc. 139, 11277-11287 (2017).
39. Montoya, J. H., Shi, C., Chan, K., & Nçrskov, J. K. Theoretical insights into a CO dimerization mechanism in CO₂ electroreduction. J. Phys. Chem. Lett. 6, 2032-2037 (2015).
40. Seh, Z. W. et al. Combining theory and experiment in electrocatalysis: Insights into materials design. Science 13, 4998 (2017).
41. Yamamoto, S., et al. In situ x-ray photoelectron spectroscopy studies of water on metals and oxides at ambient conditions. J Phys. Condens. Matter 20, 184025 (2008).

42. Xiao, H., Cheng, T., & Goddard III, W. A. Atomistic mechanisms underlying selectivities in C₁ and C2 products from electrochemical reduction of CO on Cu(111). J. Am. Chem. Soc. 139, 130-136 (2016).
43. Gao, D. et al. Plasma-activated copper nanocube catalysts for efficient carbon dioxide electroreduction to hydrocarbons and alcohols. ACS Nano 11, 4825-4831 (2017).
44. Kim, D., Kley, C. S., Li, Y., & Yang, P. Copper nanoparticle ensembles for selective electroreduction of CO₂ to C₂-C₃ products. PNAS 114, 10560-10565 (2017).
45. De Luna, P. et al. Catalyst electro-redeposition controls morphology and oxidation state for selective carbon dioxide reduction. Nat. Catal. 1, 103-110 (2018).
46. Kim, J. et al. Branched copper oxide nanoparticles induce highly selective ethylene production by electrochemical carbon dioxide reduction. J. Am. Chem. Soc. 141, 6986-6994 (2019).
47. Jung, H. et al. Electrochemical fragmentation of Cu₂O nanoparticles enhancing selective C—C coupling from CO₂ reduction reaction. J. Am. Chem. Soc. 141, 4624-4633 (2019).
48. DeWulf, D. W., Jin, T., & Bard, A. J. Electrochemical and surface studies of carbon dioxide reduction to methane and ethylene at copper electrodes in aqueous solutions. J. Electrochem. Soc. 136, 1686-1691 (1989).
49. Engelbrecht, A. et al. On the electrochemical CO₂ reduction at copper sheet electrodes with enhanced long-term stability by pulsed electrolysis. J. Electrochem. Soc. 165, J3059-J3068 (2018).
50. Zhu, W. et al. Monodisperse Au nanoparticles for selective electrocatalytic reduction of CO₂ to CO. J. Am. Chem. Soc. 135, 16833-16836 (2013).
51. Kresse, G., Furthmüller, J., & Hafner, J. Theory of the crystal structures of selenium and tellurium: the effect of generalized-gradient corrections to the local-density approximation. Phys. Rev. B 50, 13181 (1994).
52. Kresse, G., & Furthmüller, J. Efficiency of ab-initio total energy calculations for metals and semiconductors using a plane-wave basis set. Comput. Mater. Sci. 6, 15-50 (1996).
53. Kresse, G., & Furthmüller, J. Efficient iterative schemes for ab initio total-energy calculations using a plane-wave basis set. Phys. Rev. B 54, 11169 (1996).
54. Perdew, J. P., Burke, K., & Ernzerhof, M. Generalized gradient approximation made simple. Phys. Rev. Lett. 77, 3865 (1996).
55. Kresse, G., & Joubert, D. From ultrasoft pseudopotentials to the projector augmented-wave method. Phys. Rev. B 59, 1758 (1999).
56. Grimme, S., Antony, J., Ehrlich, S., & Krieg, H. A consistent and accurate ab initio parametrization of density functional dispersion correction (DFT-D) for the 94 elements H-Pu. J. Chem. Phys. 132, 154104 (2010).
57. Mathew, K., Sundararaman, R., Letchworth-Weaver, K., Arias, T. A., & Hennig, R. G. Implicit solvation model for density-functional study of nanocrystal surfaces and reaction pathways. J. Chem. Phys. 140, 084106 (2014).
58. Henkelman G. & Jo'nsson, H. Improved tangent estimate in the nudged elastic band method for finding minimum energy paths and saddle point. J. Chem. Phys. 113, 9978 (2000).

What is claimed is:

1. A catalyst comprising Cu nanowires, wherein the Cu nanowires comprise a stepped surface.

2. The catalyst of claim 1, wherein the Cu nanowires are coated on an electrode.

3. The catalyst of claim 1, wherein the Cu nanowires comprise a Cu(511) plane stepped surface.

4. The catalyst of claim 1, wherein the stepped surface comprises Cu(100) terraces adjacent to Cu(111) steps, where the terraces are formed in an axial direction and the steps are present as planes on a side surface of a Cu nanowire.

5. The catalyst of claim 1, wherein the Cu nanowires have an electrochemical surface area (ECSA) of greater than 1.68 m²/g.

6. The catalyst of claim 1, wherein the Cu nanowires have an electrochemical surface area of about 2.9 m²/g to about 3.5 m²/g or from about 3.0 m²/g to about 3.1 m²/g.

7. The catalyst of claim 1, wherein the Cu nanowires have an electrochemical surface area of about 3.07 m²/g.

8. The catalyst of claim 1, wherein the Cu nanowires have a surface roughness factor (SRF) of less than 18.

9. The catalyst of claim 1, wherein the Cu nanowires have a surface roughness factor (SRF) of 10 to 18.

10. A method of making Cu nanowires with a stepped surface, the method comprising:
preparing Cu nanowires; and
applying an electrical current under a high reduction bias thereby forming the stepped surface on the Cu nanowires;
wherein the stepped surface comprises Cu(100) terraces adjacent to Cu(111) steps, where the terraces are formed in an axial direction and the steps are present as planes on a side surface of a Cu nanowire.

11. The method of claim 10, wherein the high reduction bias is about −1.05 V.

12. A method of reducing CO₂, the method comprising:
contacting CO₂ with a catalyst comprising Cu nanowires, wherein the Cu nanowires comprise a stepped surface; and
applying an electrical current sufficient to reduce the CO₂ to form a hydrocarbon;
wherein the stepped surface comprises Cu(100) terraces adjacent to Cu(111) steps, where the terraces are formed in an axial direction and the steps are present as planes on a side surface of a Cu nanowire.

13. The method of claim 12, wherein the hydrocarbon is C₂H₄.

14. The method of claim 12, wherein the method provides C₂H₄ at a selectivity of at least 50% or at least 70%.

15. The method of claim 12, wherein the method provides C₂H₄ at a selectivity of about 75%.

16. The method of claim 12, wherein the method provides C₂H₄ at a selectivity of from about 50% to about 85%.

17. The method of claim 12, wherein the Cu nanowires have a stability of greater than 10 hours.

18. The method of claim 12, wherein the Cu nanowires have a stability of from about 10 hours to about 250 hours.

19. The method of claim 12, wherein the Cu nanowires have a stability of about 200 hours.
